(19) United States
(12) Patent Application Publication
(10) Pub. No.: US 2024/0362423 A1
(43) Pub. Date: Oct. 31, 2024

(54) Method to use history of persisted facts to improve automation accuracy and create dynamic dashboards

(71) Applicant: Kognitos, Inc., San Jose, CA (US)

(72) Inventors: Siddharth Agrawal, Bengaluru (IN); Aaron Dean BROWN, Wausau, WI (US); Binny Sher Gill, San Jose, CA (US); Rupesh Mehta, Mountain View, CA (US); Aditya Sethuraman, Palo Alto, CA (US)

(73) Assignee: Kognitos, Inc., San Jose, CA (US)

(21) Appl. No.: 18/765,237

(22) Filed: Jul. 6, 2024

Related U.S. Application Data
(63) Continuation-in-part of application No. 18/649,946, filed on Apr. 29, 2024.
Application No. 18/649,946 is a continuation of application No. 17/452,047, filed on Oct. 22, 2021, now Pat. No. 11,972,222.
(60) Provisional application No. 63/525,618, filed on Jul. 7, 2023.
(60) Provisional application No. 63/105,176, filed on Oct. 23, 2020.

(51) Int. Cl. G06F 40/40; G06F 8/33; G06N 5/022; G06N 5/04

(52) U.S. Cl. CPC G06F 40/40; G06F 8/33; G06N 5/022; G06N 5/04

(57) ABSTRACT

Disclosed is an improved approach to review and analysis a history of recorded facts for automation runs. This can be used to improve automation accuracy and to create dynamic dashboards.

### CROSS-REFERENCE TO RELATED APPLICATIONS

The present application claims the benefit of priority to U.S. Provisional Application No. 63/525,618. The present application is a continuation-in-part of U.S. patent application Ser. No. 18/649,946, which is a continuation of U.S. patent application Ser. No. 17/452,047, which claims the benefit of priority to U.S. Provisional Application No. 63/105,176. Each of these prior applications is hereby incorporated by reference in its entirety.

### BACKGROUND

Software programming involves the process of identifying desired behavior from a computer system, and generating computer code to functionally cause the computer system to implement the desired behavior. This is normally done using a specialized programming language (a “native” language) such as Java or C is used to “code” specific behaviors into a computer system. This may also be done through natural language processing (NLP), which permits a computing system to understand and/or act upon inputs, whether spoken or text, which are provided in a language that humans would typically use to interact with another human.

Software development is typically considered to be a difficult endeavor that requires a significant amount of skill and training to correctly implement a product from the development process. This is often due in great part to the fact that the developer is forced to write code in an abstract setting. The code has variables that represent values that will be received during the execution of the program.

The issues addressed by this disclosure is that conventional approaches to implement procedures in software code suffer from significant limitations. To explain, consider if a procedure has four steps, and all of them have been executed. Now, after examining the result some or all of these steps, the user realizes that certain facts operated upon by one or more of the steps need to be changed. Current systems cannot efficiently correct this situation. Instead, conventional system may require a re-architecture or upgrade of the software code, or perhaps a restart of the entire process of all the steps from the very beginning to address this situation.

What is needed, therefore, is an improved technological approach that overcomes some or all of the problems described above with regards to software development and programming.

### SUMMARY

Some embodiments of the invention are directed to an improved approach to review and analyze a history of recorded facts for automation runs. This can be used to improve automation accuracy and to create dynamic dashboards.

Other additional objects, features, and advantages of the invention are described in the detailed description, figures, and claims.

### BRIEF DESCRIPTION OF FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 provides a high-level illustration of an approach to implement some embodiments of the invention.

FIG. 2 provides an illustration of a system architecture for implementing some embodiments of the invention.

FIG. 3 shows a flowchart of an approach to process natural language according to some embodiments of the invention.

FIG. 4 shows an example of a procedure with a javascript body.

FIG. 5 illustrates an approach by which a procedure body can register new concepts with an optional reference to the underlying representation.

FIG. 6 illustrates a helper method.

FIG. 7 illustrates an example of a procedure with an English body.

FIG. 8 provides a flowchart of an approach to resolve missing data or a missing procedures according to some embodiments of the invention.

FIGS. 9A-G illustrates an example of how a system asks the user to supply missing information.

FIG. 10 shows a flowchart of an approach to use natural language to teach the system with a new skill according to some embodiments of the invention.

FIGS. 11A-D illustrate an approach to teach the system completely new skills in natural language.

FIG. 12 shows a flowchart of an approach to handle an edge case or exception when processing a user command.

FIGS. 13A-I illustrate approaches to perform error handling according to embodiments of the invention.

FIG. 14 shows a sample representation of a knowledge graph used to represent facts and procedures.

FIG. 15 shows a flowchart of an approach to look up a procedure.

FIGS. 16-21 illustrate tables of actions for handling parts of speech such as nouns.

FIG. 22 shows a sample computer program written in Python.

FIG. 23 shows a sample computer program written in natural language.

FIG. 24 illustrates a trace.

FIG. 25 provides an approach to implement recording of relevant information while executing natural language programs in order to facilitate natural language traces of the program at a subsequent time.

FIG. 26 shows a structured sentence (AST) that can be derived from that natural language statement.

FIG. 27 provides an illustration of a flowchart of processing for traces according to some embodiments of the invention.

FIG. 28 illustrates that the system may engage in the running of a given procedure.

FIG. 29 shows a flowchart of a sequence of steps according to some embodiments which permits a user to understand the decision steps taken by the system.

FIG. 30 provides an illustration of processing steps to generate a record of facts and procedure steps when executing an automation.

FIG. 31 shows an architecture of an automation system/platform with which embodiments of the invention may operate.

FIG. 32 shows a flowchart of an approach to implement some embodiments of the invention.

FIG. 33 shows an example of an example prompt that or provided to a LLM for this type of analysis.

FIG. 34 shows an example approach of asking a LLM to check for an anomaly in this situation.

FIG. 35 shows an illustration of information that may be recorded for an example automation run.

FIG. 36 shows an illustration of information of a dynamic dashboard.

FIG. 37 is a block diagram of an illustrative computing system suitable for implementing an embodiment of the present invention.

### DETAILED DESCRIPTION

Various embodiments will now be described in detail, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, various embodiments encompass present and future known equivalents to the components referred to herein by way of illustration.

Some embodiments of the invention are directed to an improved approach to review and analyze a history of recorded facts for automation runs. This can be used to improve automation accuracy and to create dynamic dashboards.

### Illustrative Architecture

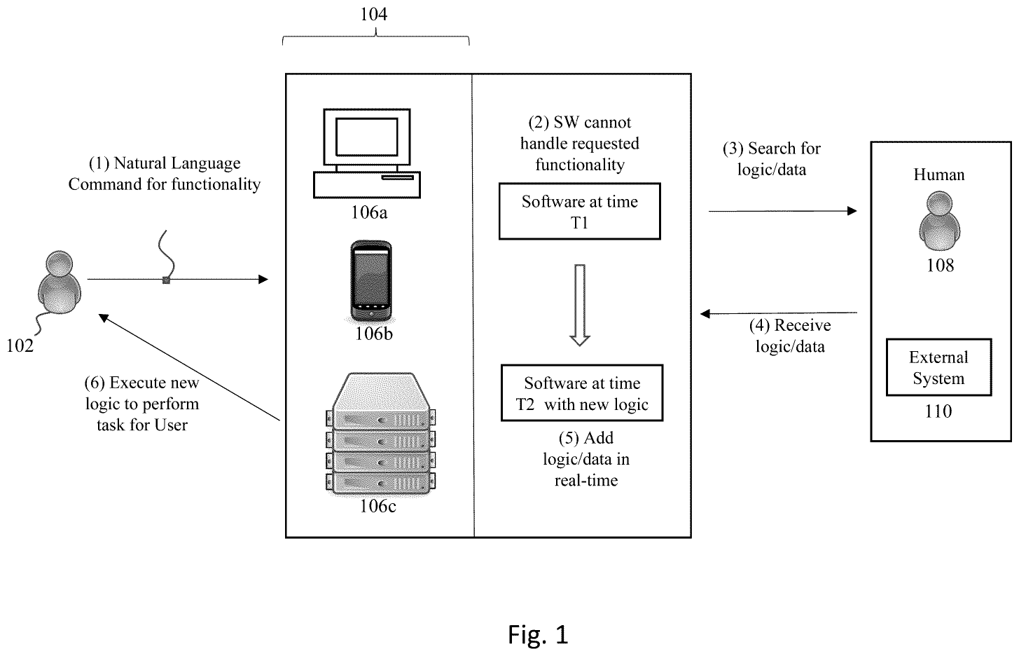

FIGS. 1-29 and their corresponding description provide an illustrative architecture and related technique(s) for implementing an automation platform, which may be used in conjunction with certain embodiments of the invention.

Humans have for a long time used mathematical constructions to program new behavior in computers. Many computer languages have been derived from lambda calculus and are mathematical in nature. The act of programming new behavior in a computer is tantamount to writing computer code in a rigid grammatical structure. Hence, programming computers has required skills that only a few are able to acquire.

On the other hand, instructing human assistants to perform a new task is usually done in natural language. This skill is natural to humans and most humans know how to instruct another human to follow a prescribed procedure.

Embodiments of the invention provide an inventive approach to use natural language to program new behaviors in computers. This approach is therefore used to implement “automations”, which describe the new behavior in the computer, where the automations are described with natural language by a user, but where the underlying automation platform will then take that natural language to implement the desired behavior. This approach therefore does not require manual programming to implement a new function or behavior into a computing or processing system. Instead, this approach will now advantageously open up myriad possibilities for human computer interaction and make all humans programmers of computers at some level.

FIG. 1 provides a high-level illustration of an approach to implement some embodiments of the invention. At (1), a human user 102 may use a natural language to provide an instruction to a processing device 104. The processing device 104 comprises any type of computing or processing device/user station that may be used to implement, operate, or interface with the user 102 to perform a computing or processing task. Examples of such devices include, for example, personal computers 106a, mobile devices 106b, servers 106c, or any other type of suitable device such as personal assistants, tablets, smart wearables, nodes, or computing terminals. The processing device 104 may comprise a display device, such as a display monitor, for displaying a user interface to users at the user station, and a speaker for voice communication with the user. The processing device/user station may also comprise one or more input devices for the user to provide operational control over the activities of the system, such as a microphone to receive voice inputs, or a mouse or keyboard to manipulate a pointing object in a graphical user interface to generate user inputs. The processing device 104 may be communicatively coupled to a storage apparatus (e.g., a storage subsystem or appliance) over a network. The storage apparatus comprises any storage device that may be employed by the system to hold storage or executable content.

At (2), an attempt is made using software operated by the processing device 104 to process the user command. At this point, consider if the software operated by the processing device is unable to handle or process the input by the human user. This may occur, for example, because the requested functionality is just completely missing from the logic built into the software. In other words, the programmer that wrote the software did not write programming code to implement the desired functionality, perhaps because the programmer did not anticipate that a user would request that functionality.

Another possible reason for the software to fail to process the user input is because of an error or exception that occurs during processing, e.g., where the software is operated with wrong data or a wrong procedure. Both humans and machines will get a bad result if they were given wrong data or a wrong procedure to begin with. However, once a machine gets a bad result, there is generally no easy way for redoing the task with the fixed data or logic. Humans will discover the bad data or logic, then learn what the right data or logic should have been and then redo the portion of the task that needs to be tried again to get to the right result.

Another class of problems that may arise pertains to environmental failures. A human when presented with an environmental failure (say the house loses power, or the internet connection goes down), will pause doing the task they were doing, fix the environmental issue, and then resume the task they were working on originally. The logic for fixing the environmental issue need not be part of the procedure that they were working on. It is injected in an ad hoc manner to handle the unexpected event of the failures in the environment. Computing systems behave differently. If the environment failure was not expected and handled in the given logic in the program being run, the program will simply crash. There is no way for the program to wait and have a human or another program fix the environmental issue allowing the original program to resume.

These stark differences between how machines and humans behave when faced with problems is the fundamental reason why programming is a skill that requires training and only a relatively small fraction of humans have the training or experience to be able to effectively program machines. The programmer is forced to think up-front about all the above classes of errors and either make sure that these errors do not happen or write logic to gracefully handle these errors when and if they happen. It is not a trivial task to make sure that a computer program specify logic in an up-front manner that can handle all unexpected scenarios. This realistically limits the art of good programming to only highly experienced and skilled programmers.

As is evident, one main difference between computers and humans is that in most cases computers have to be instructed up-front what to do, while humans can learn “on-the-job”, especially when a problem occurs while performing a task. For example, when performing a task, if a human realizes that some data is missing, the human turns to someone who might have the missing data, and learns the new data and continues doing the task. Computing systems will crash in such a situation unless the developer a priori writes logic to handle the unexpected case. Similarly, when a human is doing a task and realizes that they do not know how to do something, they ask someone who can teach them the skill, they learn and then continue. A computing system may present a compile error and refuse to start doing the task, or worse will crash in the middle of a running task with no recourse to learn on the job.

With embodiments of the invention, the processing device is configured to “learn” how to address the above-described problems, similar to the way that a human would tackle such problems and unlike any existing software paradigm for handling such problems. In particular, the current inventive embodiments provide systems and methods that address the above problem(s) and exhibit human-like error handling in computing systems. Therefore, at (3), the inventive embodiment will search for and learn the appropriate logic and/or data that is needed to address the identified problem that the current software is having with being able to process the user command. Some or all of the following may be addressed: (a) Missing Data; (b) Missing Logic; (c) Wrong Data; (d) Wrong Code; (e) Unexpected Situation; and/or (f) Incomplete code. Each of these solutions will be described in more detail below.

The process of learning the solution may cause the system to receive information from any suitable source. For example, at (4), the new logic or data may be received from a human 108 or any external computing system 110. The external system may comprise any machine-based source of information, such as a website, knowledgebase, database, or the like.

At (5), the software will learn the new behavior during its current runtime. This means that the software will add the new logic or data while it is still running, and will continue to operate without exiting from or stopping its current execution. At (6), the modified software will then use the new logic/data to perform the originally requested task from the user.

In some embodiment, the system allows for code to change during runtime if the user so prefers. In traditional computer languages, it is not possible to pass a new parameter to a called procedure during runtime because adding a new parameter requires the source code to change in both the calling and called procedure. This makes it hard to build a system that can allow such changes at runtime. However, in some embodiments of the current invention, it is possible for a called procedure to obtain an unforeseen parameter at runtime. This is possible because the calling procedure is not mandated to provide all the parameters when calling the called procedure. The called procedure has the ability to pull parameters on its own accord from the knowledge graph or the user without having to change anything in the calling procedure. This provides tremendous flexibility to change code on the fly. Further, given that the system does not crash but rather asks the user anytime it needs some clarification (like confusion between two items with the same name, like two Johns, or two ways to send, etc.), the system further lends itself well to runtime adaptation without having to start from the beginning as many computer systems require.

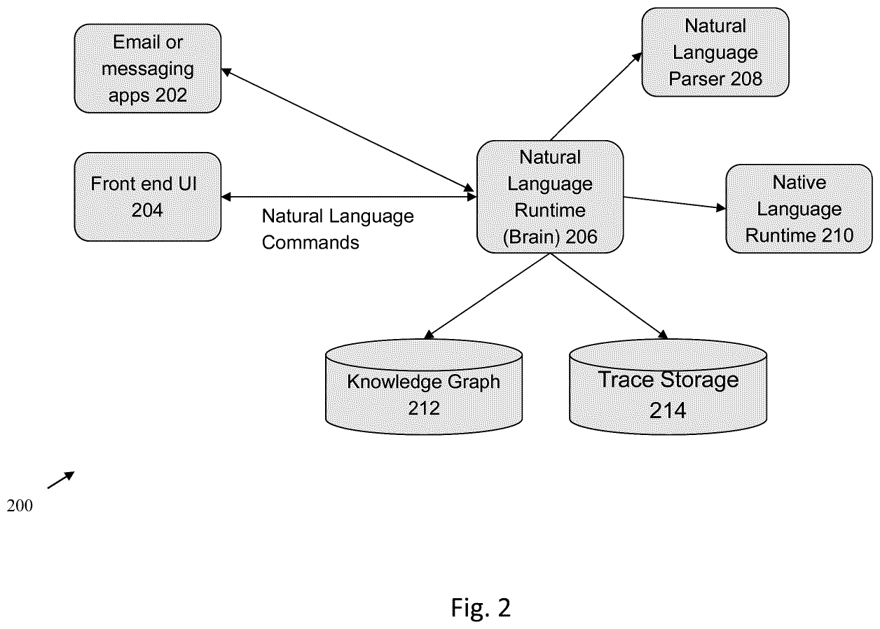

FIG. 2 provides an illustration of a system architecture 200 for implementing some embodiments of the invention. The system 200 includes both a natural language runtime 206 and a native language runtime 210. The natural language runtime 206 performs processing on the basis of natural language processing inputs. The native language runtime 210 performs processing on the basis of computer code that is written to run “natively” in the system. Native languages are traditional computer programming languages such as, for example, Javascript, Python, Java.

The system 200 includes a knowledge graph 212 that can represent facts, procedure and rules. The knowledge graph 212 is a searchable entity that is capable of being queried to identify entries that are stored within the graph. The knowledge graph 212 in some embodiments is constructed with the understanding of inheritance and thus, when taught that “a dog is a mammal” and “Tony is a dog”, understands that “Tony is a mammal”.

In operation, a front end user interface 204 is employed to receive natural language commands into the natural language runtime 206. Additional inputs may be received via other applications 202, such as email or messaging applications. A natural language parser 208 may be used to parse the natural language inputs received from the front end UI 204 or the email or messaging applications 202.

The natural language runtime (“brain”) 206 and the native language runtime 210 operate in conjunction with one another to process the user commands. For example, as described in more detail below, parameters may be passed through the knowledge graph 212 between the natural language runtime 206 and the native language runtime 210 to execute the user command.

The system 200 may also include storage 214 (e.g., a short term memory) where it holds a running context of what is performed in the system, e.g., for tracing purposes. In some embodiments, that context includes all commands run, facts observed, and entities resolved. The context also keeps track of asynchronous tasks that are marked with words like “whenever, while, continuously, after 10 seconds, tomorrow, every week, every alternate day, every second Monday of February”, etc. Under the context of each asynchronous task, the system remembers the time stamp of each time it was invoked and the details of each statement run and the result, if any, obtained.

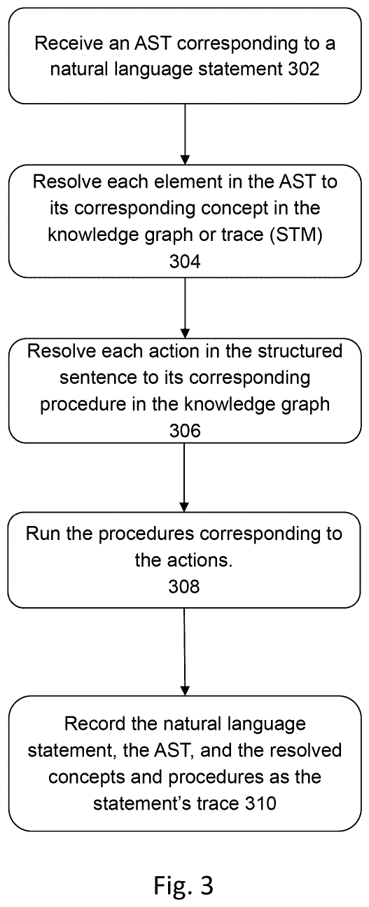

FIG. 3 shows a flowchart of an approach to process natural language according to some embodiments of the invention. The processing generally proceeds by analyzing the words and symbols in a natural language statement. At 302, the processing receives an abstract syntax tree (AST) that corresponds to the natural language statement. The AST can be generated based on the technique described herein. The natural language text is processed to determine the role of each word and symbol in the statement. This is done in some embodiments by using a neural network trained to do so using any of the common AI-based classification techniques. The AI (‘artificial intelligence”) models are trained on not only English statements but also statements that include or are completely comprised of mathematical phrases like “1+1”, “john's age*2”, “the answer”, “add 2*log(100) to the bank account”. The AI parser outputs the roles of each word and symbol in the statement, which proceeds to the next phase.

The statement with the annotated roles of the words and symbols are processed and converted into the abstract syntax tree that captured the structure of the statements in terms of the traditional grammatical constructs like subject, predicate, object, verb, adjective, adverbs, prepositions, etc. The AST captures the structure of the English (or for that matter any natural language) statement.

One such example of a tree is the traditional ‘sentence diagramming’ as taught in the English grammar book ‘Rex Barks’. However, other equivalent structures can be used. One can use a structure that captures not only the parts of speech, but also the type of sentence as well as the semantic operations required to resolve the concepts in the sentence. For example, “any of the scene's bricks” is translated to:

```
“any”,
  [ “possessive”,
    [ “determinant_name”,
      “the”,
      “scene”,
      null
    ],
    { “members”: “bricks” }
  ],
```

The AST supports different types of natural language statements like declarative, interrogative and imperative/procedural.

Declarative statements usually provide a piece of knowledge that the system represents in a knowledge graph of concepts. Each concept can have inbound and outbound relations to other concepts. The relations between the concepts in the knowledge graph can be “is a”, “is name of”, “corresponds to”, or any regular relation typically encountered in natural language (“brother of”, “car of”, etc.) or in relational databases. The concepts can optionally have a value (“john's age is 21”). Declarative statements update the knowledge graph using relations between concepts and values stored within concepts. Some declarative statements define how to compute things. For example, “a number's square root is . . . ” is the start of a declarative statement that defines how to find out the square root of any number. Such statements create conceptual nodes in the knowledge graph that are referred to when those kinds of entities need to be evaluated. Note that the procedure to evaluate an entity can be given in either English (“a number is odd if the number is not even”) or in a standard computer language like javascript. Some declarative statements define how to do things, For example, “to send a message to a person . . . ”. This statement is the start of a procedure that defines how to send a message to a person. This is stored in a conceptual node in the knowledge graph and invoked when a concept action like “send ‘hello’ to John” is called, where the system knows that ‘hello’ is a message and John is a person.

Interrogative statements essentially traverse the knowledge graph that was created as a result of declarative statements and present the answer to the user.

Imperative statements execute actions and are processed to find out the verb and the associated objects, prepositions, adjectives, etc. Then, all the known procedures that match the classes of the concepts are examined to find the best match. That matched procedure is then executed with the given concrete concepts. For example, “a friend is a person. John is a friend. send the shop's summary to John” resolves into the verb “send” that acts on “the shop's summary” which is of the class ‘string’ and the prepositional object is John who is of the class friend, which in turn is of the class person. All known procedures that agree with the class of the concepts in the imperative statement are examined and the closest match is executed. If there is a confusion as to which one to run, the user is given the choice to pick the one to run. A procedure in turn can be a collection of statements which are processed sequentially according to the method described above. The collection of statements could also be in a native computer language, in which case the set of statements are run using a standard interpreter for those languages.

At 304, nouns within the AST are resolved to the knowledge graph. For example, the nouns within the AST can be resolved to its corresponding concept within the knowledge graph and/or trace. At 306, actions within the AST are resolved to the knowledge graph. For example, each action in a structured sentence within the AST can be resolved to its corresponding procedure within the knowledge graph.

There is the notion of environments that is key to the selection of both data from the knowledge graph as well as procedures from the knowledge graph. For example, the system can be programmed to do the same task in different ways in different environments. Environments can be temporal or spatial. For example, “while in India, to order lunch . . . ” versus “while in America, to order lunch . . . ”. Here, ‘while in India/America’ is the environment. In both environments, the same procedure “to order lunch” has been defined. The system can be informed that it is in an environment via a simple statement like ‘you are in India”. That allows the system from then on until it exits the environment, to choose both facts and procedures that are relevant to the environment.

At 308, the processing will thereafter run the procedures that correspond to the actions. At 310, recording is performed of information pertaining to the execution of the procedures. For example, the system may record the natural language statement, the AST, and the resolved concepts and procedures as the statement's trace.

With regards to procedures, it is noted that the procedures can be defined with a natural language name or header. In some embodiments, there are no function names or formal arguments as in traditional computer languages. The body of the procedure can itself be in natural language or can be in any of the traditional computer languages.

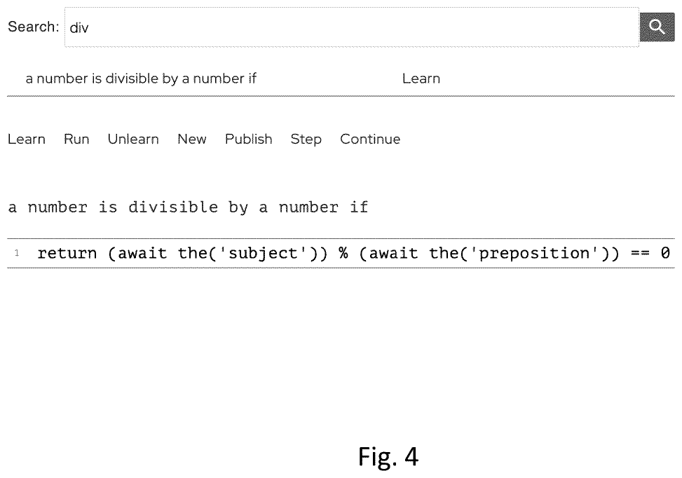

An example of a procedure with a javascript body is shown in FIG. 4. Here, the javascript or any other language body accesses the parameters of the procedure call via parts-of-speech access methods. They can also access parameters or other entities in the call-stack context via the named entities like: “await the (‘number’)” or “await the (“cars”)”. These access methods are very flexible and allow for accessing potentially all of the knowledge graph by using traversal routines.

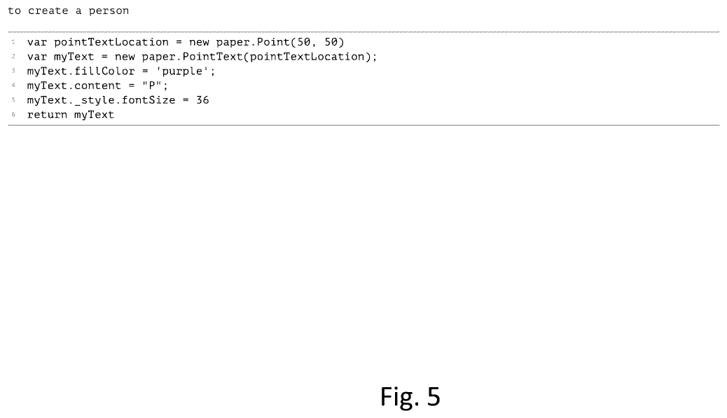

There are also methods by which the procedure body can register new concepts with an optional reference to the underlying representation. An example of this shown in FIG. 5. Here, the javascript routine creates an entity in memory and returns it. The reference to myText is then kept in the knowledge graph as an external reference that is made available to the lower programming layer anytime the same ‘person’ is accessed by the lower layer. This allows for a clean separation of the English and non-English programming paradigms while allowing for reference passing between the two layers across time and space.

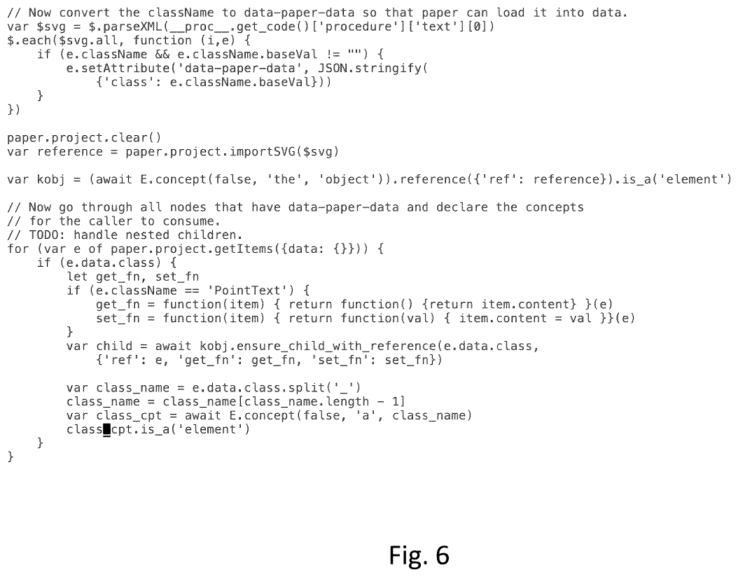

A new concept with a reference can also be explicitly created with a helper method as in the “var kobj . . . ” statement in FIG. 6. There is another instance in FIG. 6, where “kobj.ensure_child_with_reference ( . . . )” is creating a child of an existing concept in the knowledge graph but also provides a reference (ref) and get (get_fn) and set (set_fn) functions for manipulating the value of what the reference points to.

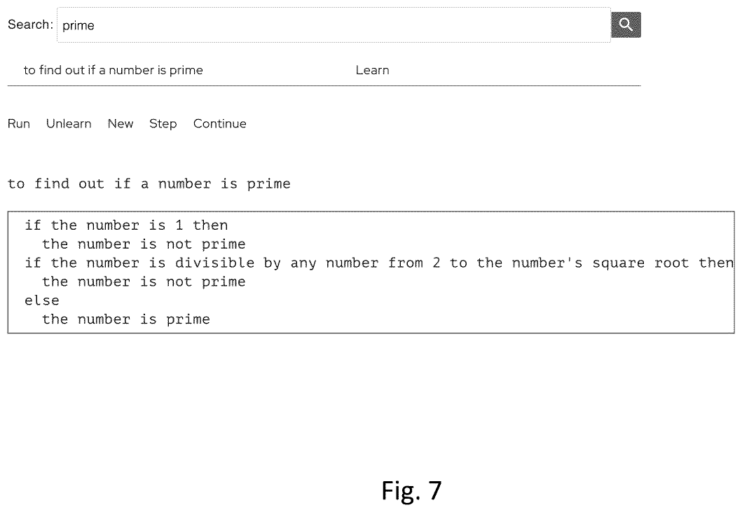

An example of a procedure with an English body is shown in FIG. 7. Note that other than indentation that provides clarity of which statements to run in the “if” and the “else” sections of the logic, there is not any punctuation, symbols or syntax to worry about for the user who writes the natural language code.

As previously noted, one of the problems in conventional automation is that when any piece of automation hits an error, unless the developer had foreseen the error condition and has provided error handling code, the automation simply “crashes”. This is very different from how intelligent beings like humans or even animals behave. Intelligent beings get “stuck” on hitting unforeseen conditions and wait for help. This particular behavior has not been possible in computer science so far.

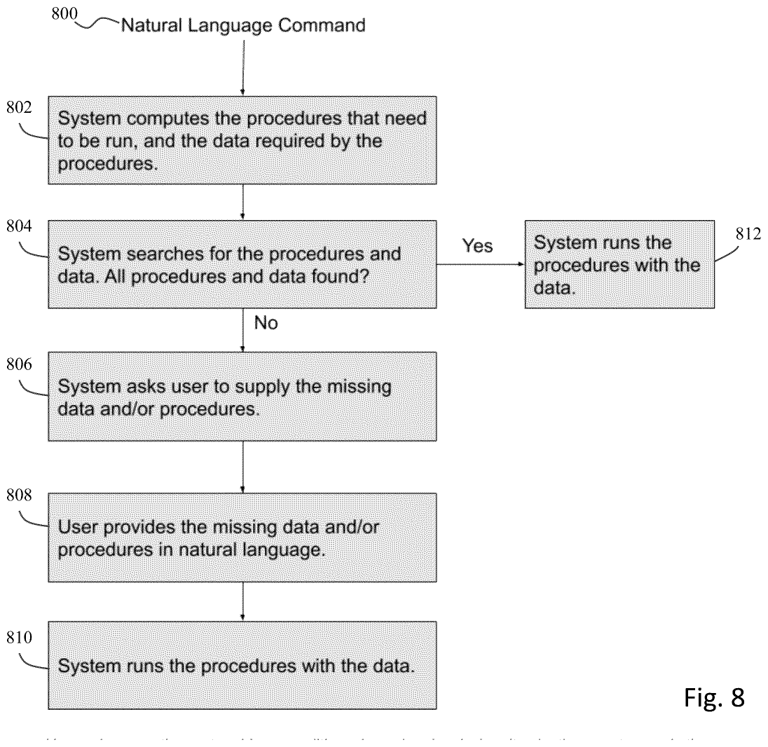

FIG. 8 provides a flowchart of an approach to resolve missing data or missing procedures according to some embodiments of the invention. The processing begins when a natural language command 800 is received into the system. At 802, the system makes a determination of the procedure that is needed to be run and/or the data required by the procedure. This action may be performed, for example, by searching the knowledge graph for the pertinent procedure or data.

At 804, a determination is made whether the required procedure and/or data has been found. If found, this means that the system has the requisite content (logic or data) to perform the requested user command. The requisite content may have been coded into the system by a developer, or may have been included into the system by a prior iteration of the current process based upon a prior user command. Regardless, if the required procedure/data is found, then at 812 the system runs the procedure with the data to execute the functionality needed to handle the user's natural language command.

If the required procedure and/or data is not found, then the processing continues to acquire the necessary procedure or data. The procedure or data may be acquired in any suitable manner. The process may be based upon an automated search of a secondary source, or based upon a request to a user to supply the missing content. In the embodiment of the current figure, at 806, the system asks a user to supply the missing data and/or procedure. At 808, the user provides the missing data and/or procedure in natural language. The system, at 810, can then run the procedure with the data.

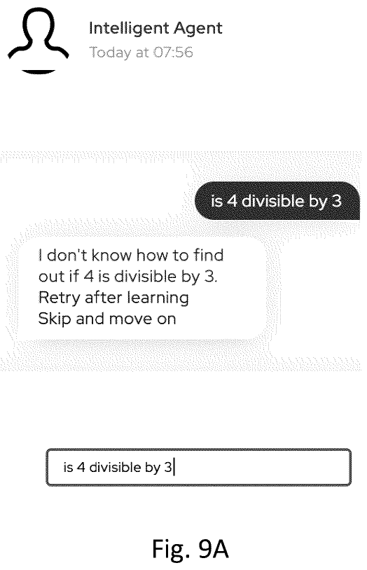

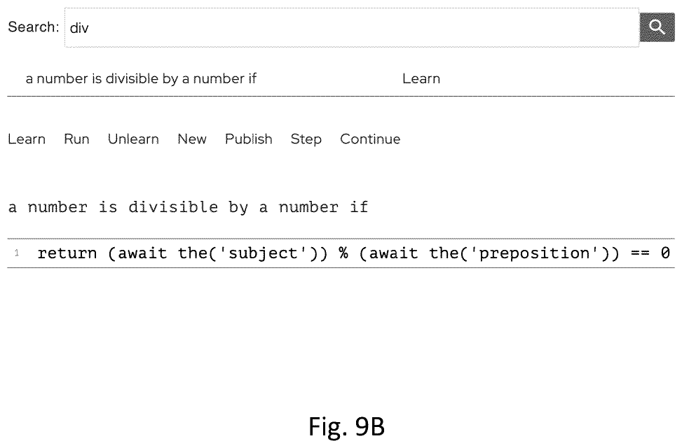

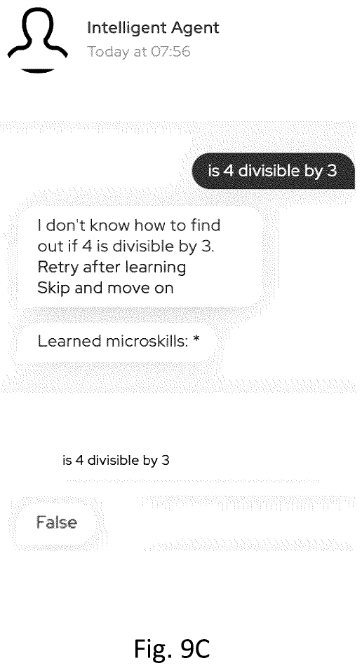

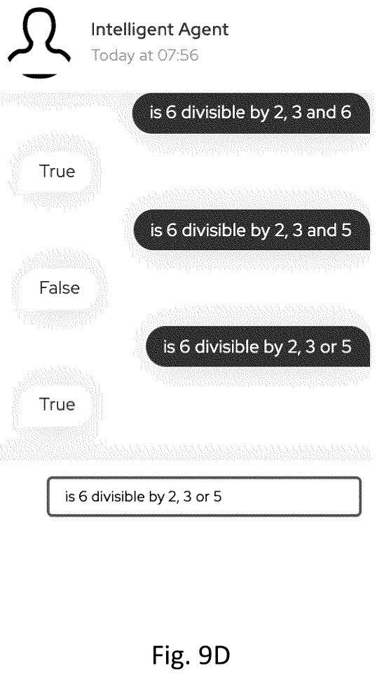

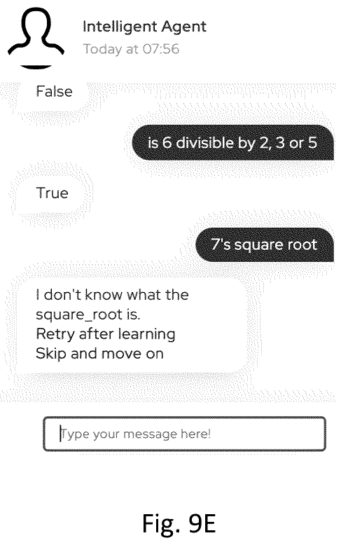

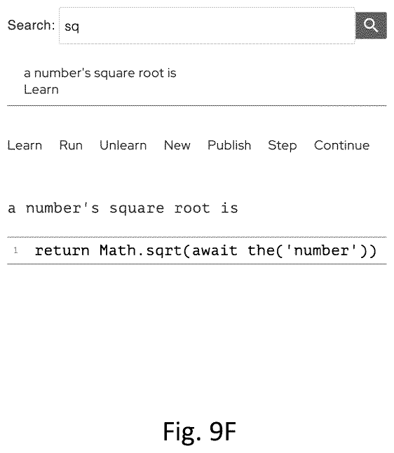

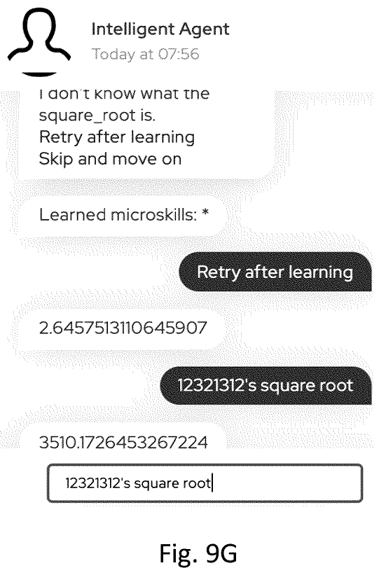

An example of how the system asks the user to supply missing information is shown in FIGS. 9A-G. These figures provide an illustration of a situation where the user is requesting the system to determine if a number is divisible by another number. As shown in FIG. 9A, the system provides a response indicating that the system does not yet have enough knowledge to perform the requested task. As such, the system can ask the user to teach it the skill. As shown in FIG. 9B, the user either types in the procedure or searches for the procedure in a collection of skills and playbooks available in one or more central repositories (hosted publicly or privately in an enterprise). The user then instructs the intelligent agent to learn the skill, e.g., by pressing the ‘Learn’ button in the user interface. In one embodiment, the act of searching for the matching skill and learning can be automatic (e.g., where the author of the skill was pre-approved or trusted by the user).

As shown in FIG. 9C, the intelligent agent indicates that it has learned the new micro-skill. After the intelligent agent has learned how to compute what was required it continues with the job without having to restart, and prints the answer “False” correctly to the problem it was trying to solve: “is 4 divisible by 3”. Subsequently, the agent is automatically able to apply the skill to a list of numbers and further understands how to process ‘and’ vs. ‘or’ in a list of options. This is achieved by applying the single object case multiple times and then based on whether it is and/or/at least <num>/at most <num>/etc. determining what the answer should be. This is shown in the interaction with the agent in FIG. 9D.

As another example, assume that the user proceeds to ask the system to answer a question such as the square root of a number, e.g., as shown in FIG. 9E. If the system knows how to evaluate that, then it will report the answer; otherwise, it will ask the user to teach it how to handle the requested functionality. The user can also ask the system to simply skip the action and move on. The user then either types in, dictates using text-to-speech, or searches a central repository for a matching procedure to do the job as shown in FIG. 9F. The system can also automatically search a central repository and use the found procedures to update the system with the new functionality.

After the system has learned the procedure, the user can ask the intelligent agent to proceed. In another embodiment, the intelligent agent can self-detect that the relevant skill that was missing has been learned and automatically proceed with any prior stuck procedures. The system is then capable of answering further questions regarding square roots of numbers as shown in FIG. 9G.

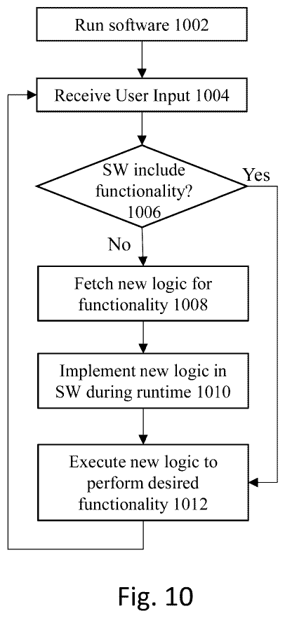

As is evident, embodiments of the invention are capable of teaching a system to use completely new skills using natural language. FIG. 10 shows a flowchart of an approach to use natural language to teach the system with a new skill according to some embodiments of the invention.

At 1002, the software is run in correspondence with an appropriate processing device, such as a mobile device, smart assistant, or personal computer. The software comprises a natural language processor as described earlier in this document.

At 1004, a user input is received that includes a request to perform a function or task. The user input comprises any suitable type of input. For example, the user input may correspond to a natural language input that is either spoken or typed into the system.

At 1006, a determination is made whether the software currently includes the functionality to perform the user command. The functionality may have been included by the original programmer that developed the software, or it may have been learned using a past iteration of the current process. The search may be performed, for example, by searching a knowledge graph for the required procedure.

If the functionality already exists in the software, then the processing goes to step 1012 to execute the functionality to perform the user command. An identified procedure from the knowledge graph is used to execute the desired functionality.

On the other hand, it is possible that the software within the system does not yet have the required functionality to perform the user command. If this is the case, then at 1008, new logic is fetched to implement the desired functionality. The new logic may have been identified by automated searching of a knowledgebase. The new logic may also be provided by a user. In either case, natural language inputs from the user may be used to search for, provide, and/or confirm that an identified item of logic is the appropriate log to implement the desired functionality.

At 1010, the new logic is implemented into the system. This may be performed, for example, by using the new logic to implement a procedure that is then included into the knowledge graph with respect to the desired functionality. Thereafter, at 1012, the new logic is executed to perform the desired functionality. This approach therefore permits the learning of a new skill (or any other error correction as described herein) to be performed during the runtime of the software, without requiring execution of the software to be terminated (e.g., without terminating execution to recompile the software). This is because, after the knowledge graph is modified to include the new procedure/data, a subsequent iteration through the sequence of steps will then identify the necessary procedure/data by a subsequent query of the knowledge graph to perform the requested user command-even if it was not found the first time through the knowledge graph.

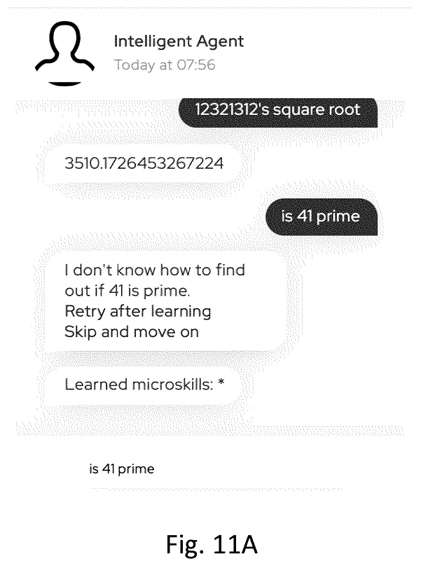

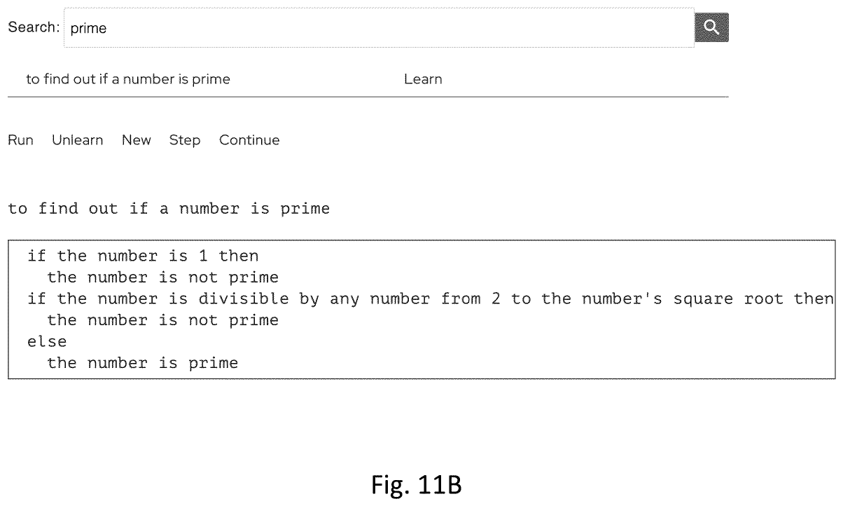

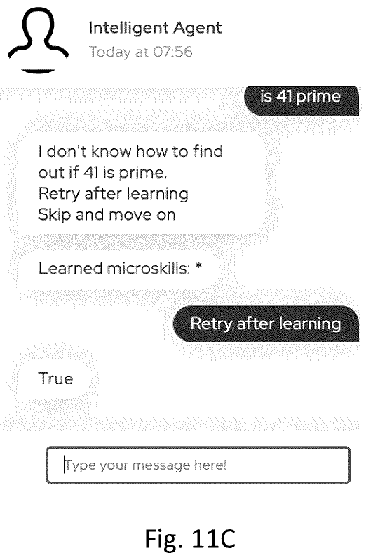

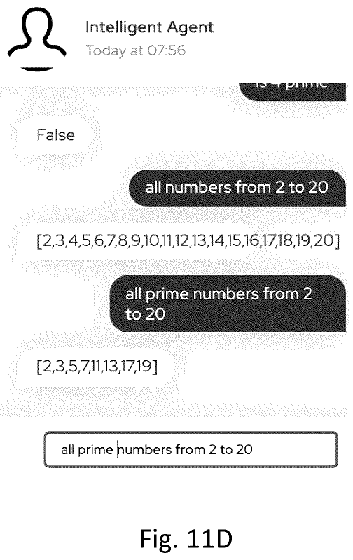

As illustrated in FIG. 11A-D, the system can now teach the system completely new skills in pure natural language. The lowest level actions are most likely in a traditional computer language like javascript, while the higher level glue-code or business logic can be in a pure natural language like English. An example of such an interaction is shown in these figures, where the system initially does not know how to do a task but then learns how to do it via a purely natural language instruction.

As shown in FIG. 11A, the system is asked “is 41 prime” by the user to determine whether the number “41” is a prime number. It is assumed that the system does not yet include functionality to perform this requested action by the user.

Here, the system knows that ‘prime’ is likely a word that describes the subject “41”. However, in its knowledge graph, the system does not have any knowledge of what ‘prime’ could mean. Hence the system tells the user that it does not know how to find out if 41 is prime. The user can then type in, or point out otherwise, the procedure to find out if a number is prime as shown in the example procedure in FIG. 11B. It is noted that in the procedure of FIG. 11B, there are no function names, function parameters, return values, computer language symbols or even language punctuations (other than apostrophe) including capitalization. While adding more symbols and structure makes it easier to build a parser for the language, and most computer languages tend to overdo this, the added structure results in making the language hard to understand and learn for non-programmers. It is non-trivial to achieve this clean exposition of a program and it is done using many techniques, some of which are described below.

In some embodiments, capitalization is optional even for proper nouns. The reason is that when verbally dictating to a computer, the notion of capitalization may not be captured. Further, there are written natural languages like Hindi that do not have the feature of capitalization. Since this system is designed to work for any natural language, the current embodiment stays away from features that are not generally available in other languages. The AI-based model that is used to determine the role of words in a statement is trained to guess whether a word is a proper noun or not. In case it gets it wrong, there is a subsequent parsing step where based on the knowledge in the knowledge graph, the labelling can be corrected. That comes in useful when there are words that can be both a proper noun or an adjective, etc. based on the context. Like “hardy was there early”, “he is hardy boy”. Here “hardy” can be a proper noun or an adjective.

In certain embodiments, no function names are required because the system uses the natural description of the thing being computed or the task being performed as the name for the procedure. For example, “to find out if a number is prime” is in pure English, while in any traditional computer language, it would be something like “bool is prime (num)”. Such a syntax that is derived from lambda calculus makes it hard and unintuitive for non-programmers to start programming.

There are also no parameters required in some embodiments. That is because the current approach has inverted the way programs are executed. In traditional computer languages, the data is passed to the procedure while in the current model the procedure is brought into the “brain” or the knowledge graph where the instructions are interpreted and resolved into concrete instructions based on what is in the knowledge graph. Similarly, the procedure commands access whatever data they want by referring to the knowledge graph directly. If the procedure is in English it uses natural language to refer to the knowledge in the knowledge graph. The natural language can look up entities by name like ‘John’ or by determiners like ‘the employee’, ‘all friends’, ‘any 2 people from my soccer team’, ‘the last email’, etc. Natural language can also be used to refer to the procedure to run which is chosen from the most specific environment that the intelligent agent is in.

In some embodiments, there are no return codes or values. This is possible because if the procedure is to find a value or determine an answer, as soon as a valid positive or negative answer is obtained, the procedure automatically stops. The current system does not have to explicitly stop the procedure. In the above example, any time ‘the number is prime’ or ‘the number is not prime’ is declared, the system detects that it is a valid answer to the question the procedure was seeking to answer and stops further processing. This is in line with how humans behave. For example, if a person is looking for a wallet, that person might have a program in his/her head to retrace everywhere he/she has been, but the person will stop looking for the wallet as soon as it is found. The current system does not have to explicitly state, as in all computer languages, to stop processing (e.g., via a return or done statement). Further, in order to return the value, the system does not pass the answer in a return code like in traditional computer languages. Instead, the current embodiment declares a new fact that enters the knowledge graph and thus the intelligent agent is now aware of the new fact and can subsequently use that fact without having to refer to the return code of the procedure. This avoids common mistakes and also the rigidity surrounding the semantics of return codes in computer languages.

As can be seen in FIG. 11C, the system continues with trying to answer the original query of “is 41 prime” and after learning in English how to do it, it processes and provides the answer (True). Subsequently, the system is capable of applying this knowledge in other contexts which have not been explicitly taught to the system but are general patterns in human thought process and have been codified in the system. For example, just by learning whether a number is prime or not, now the system is able to filter out all prime numbers from a list of numbers as shown in FIG. 11D.

The embodiments of the invention can be used where an edge case or exception is identified when processing a user command. Unlike the previous approach where a new skill is learned for a procedure that is completely missing, this current approach can be used where the procedure exists but cannot be adequately performed because of an identified error or exception.

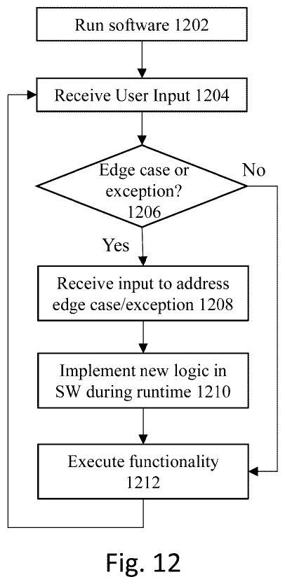

FIG. 12 shows a flowchart of an approach to handle an edge case or exception when processing a user command. At 1202, the software is run in correspondence with an appropriate processing device, such as a mobile device, smart assistant, or personal computer. The software comprises a natural language processor as described earlier in this document. At 1204, a user input is received that includes a request to perform a function or task. The user input comprises any suitable type of input. For example, the user input may correspond to a natural language input that is either spoken or typed into the system. At 1206, a determination is made whether an edge case or exception is identified for the requested functionality.

An “edge case” is a problem or situation that occurs at an extreme (maximum or minimum) operating parameter. Non-trivial edge cases can result in the failure of an object that is being engineered, particularly when they have not been foreseen during the design phase and/or they may not have been thought possible during normal use of the object. For this reason, attempts to formalize good engineering standards often include information about edge cases. In programming, an edge case typically involves input values that require special handling in an algorithm behind a computer program. As a measure for validating the behavior of computer programs in such cases, unit tests are usually created; they are testing boundary conditions of an algorithm, function or method. A series of edge cases around each “boundary” can be used to give reasonable coverage and confidence using the assumption that if it behaves correctly at the edges, it should behave everywhere else.

An “exception” corresponds to anomalous or exceptional conditions requiring special processing. In computing and computer programming, exception handling is the process of responding to the occurrence of exceptions during the execution of a program. In general, an exception breaks the normal flow of execution and executes a pre-registered exception handler; the details of how this is done depend on whether it is a hardware or software exception and how the software exception is implemented. Exception handling, if provided, is facilitated by specialized programming language constructs, hardware mechanisms like interrupts, or operating system (OS) inter-process communication (IPC) facilities like signals. In some cases, the identified edge cases correspond to problems that occur due to values of parameters, while the identified exceptions correspond to problems that occur due to the environment outside of the specification in the software program.

If at 1206 it is determined that an edge case or exception exists, then at 1208, inputs are received to address the exception or edge case. The input may have been identified by automated searching of a knowledgebase. The input may also be provided by a user. In either case, natural language inputs from the user may be used to search for, provide, and/or confirm that an identified approach to address the edge case or exception is appropriate for the current situation.

At 1210, logic is implemented into the system to address the edge case or exception. This may be performed, for example, by including the new logic into the knowledge graph with respect to the identified edge case or exception. Thereafter, at 1212, the new logic is executed to address the edge case or exception, so that the user's command is correctly executed.

In general, the basis for several of the current embodiments is to provide “human-like” error handling, which allows the system to “learn on the job” when an error is encountered. Some or all of the following error types may be addressed by embodiments of the invention: (a) Missing Data: where the typical machine behavior is to have a runtime crash, but the current embodiment will resolve the problem by asking for and learning a solution and then continue; (b) Missing Logic: where the typical machine behavior is to exhibit a compile error, but the current embodiment will resolve the problem by asking for and learning a solution and then continue; (c) Wrong Data: where the typical machine behavior will result in a bad result or a system crash, but the current embodiment will resolve the problem by discovering and learning a solution, followed by a redo of the processing; (d) Wrong Code: where the typical machine behavior create a bad result or a system crash, but the current embodiment will resolve the problem by discovering and learning a solution, followed by a redo of the processing; (e) Unexpected Situation: where the typical machine behavior is to result in a crash, but the current embodiment will resolve the problem by asking for and learning a solution, and then continuing with the processing; and/or (f) Incomplete Code: where the typical machine behavior is to assume the job is finished and terminate the process, but the current embodiment will allow for addition of new logic even after the code has run to completion,

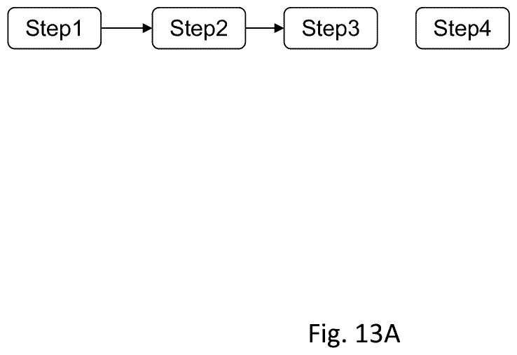

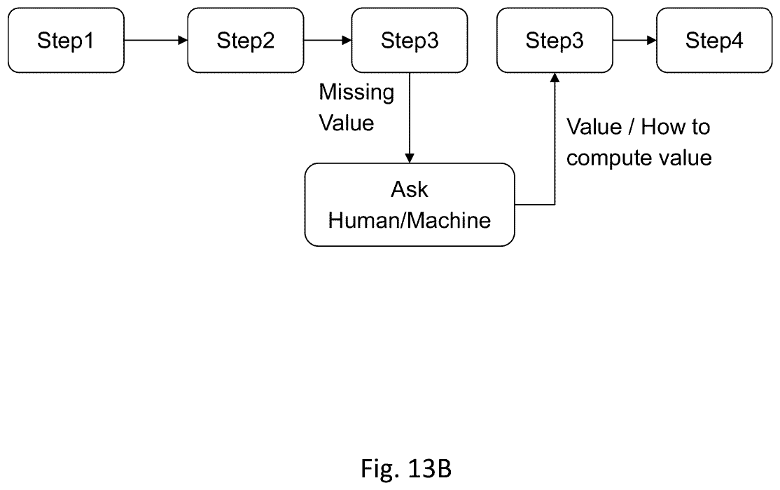

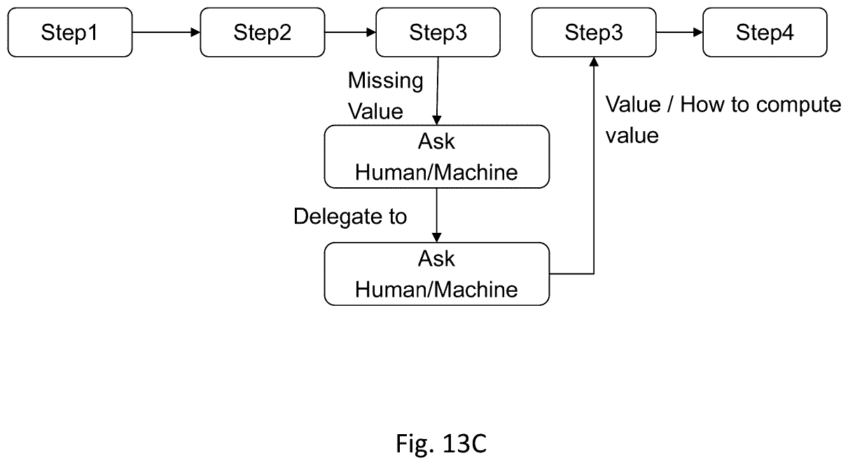

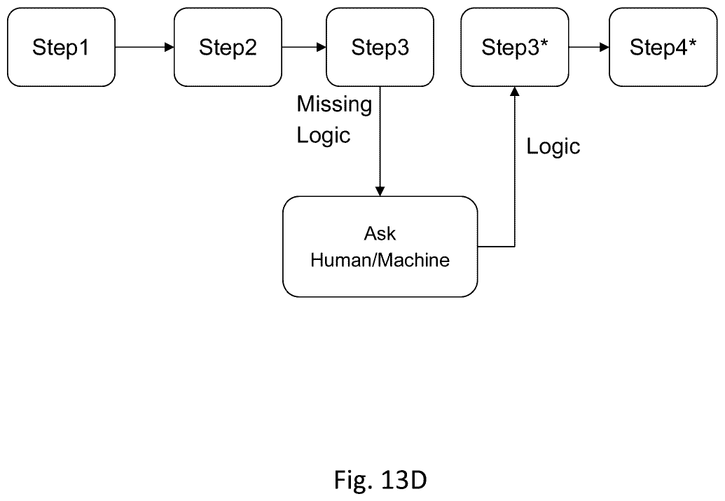

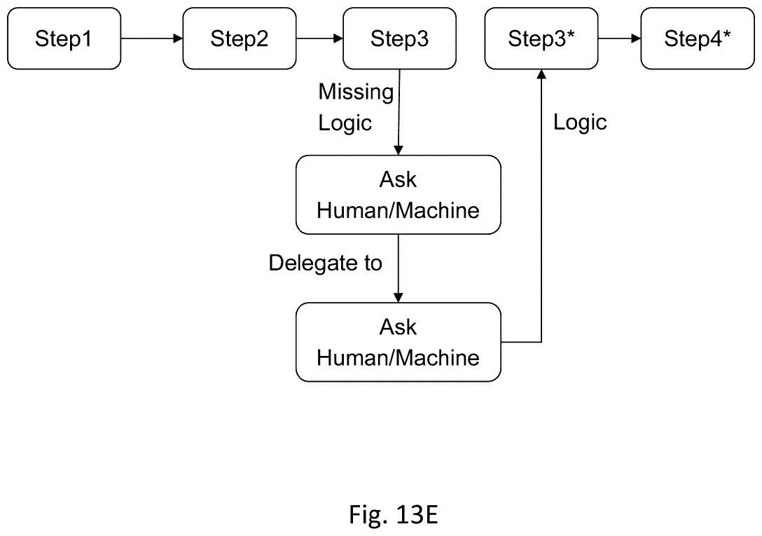

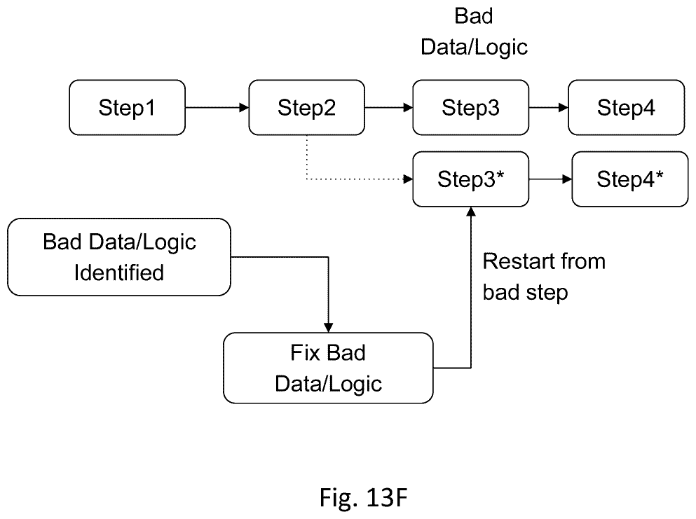

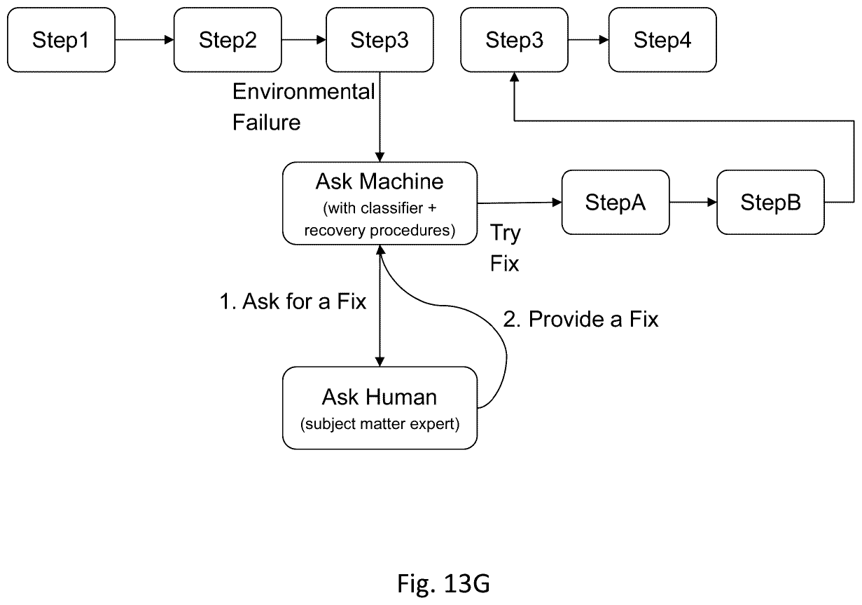

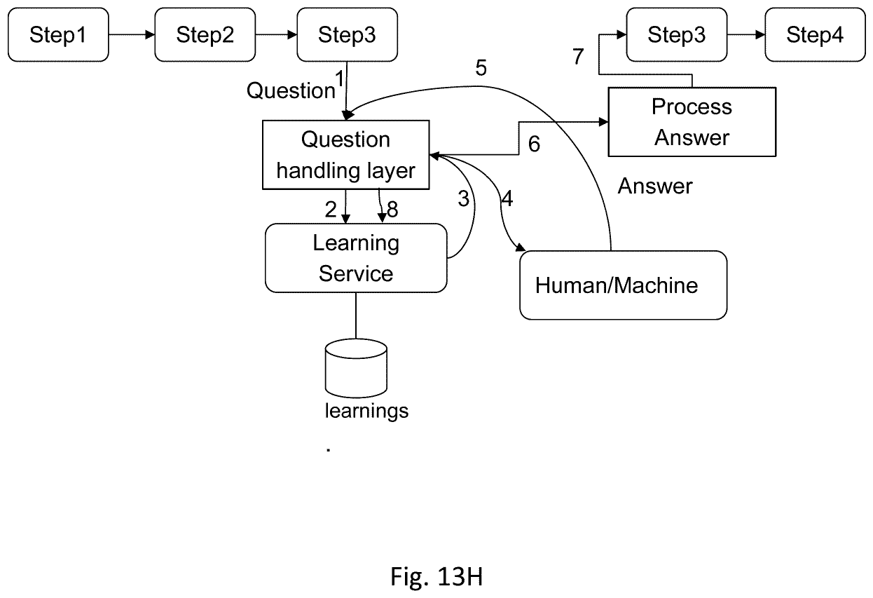

To explain, consider the case of a procedure as shown in FIG. 13A that has four steps (as an example, although it could have any arbitrary number of steps). If there is an error in Step 3, then the procedure fails at Step 3 and Step 4 is never run. The only way in the current state-of-the-art to recover from this situation is to clean up whatever side effects were done by Step1 and Step2, fixing the problem that caused the failure in Step3, and then retry the entire procedure starting with Step1. However, this approach is difficult to implement up-front because not all error cases can be foreseen by developers, or it is simply very expensive to invest in all the effort to handle the error cases.

Instead, some embodiments of the invention provide a system that can learn what to do as and when it hits these types of errors. As shown in FIG. 13B, assume that the failure in Step3 is due to a missing value, for example, the step involved adding two quantities, but the value of one of them is not known to the system. In that case, the system stops at Step3, and then reaches out to a human or another machine (a computer system) that can provide the missing value or a method (a program) to compute the missing value. Once the answer is available, the system processes the answer and then uses that in Step 3 and continues to execute the Step3 which now succeeds. After Step3, Step4 is run and it also succeeds in this case. Note that this method does not require the user to clean up the side effects created by Step1 and Step2 as those steps are not repeated.

Now, the human or machine that is asked the question could delegate the question to another human/machine who/which can return the answer to the system (as shown in FIG. 13C). This delegation chain can be of any size. Furthermore, as the delegation is happening, the question could be enriched with more context, validation rules, choices, or other useful information provided by the human/machine.

Another class of errors are the cases where the system does not know how to compute or do something. For example, the system may need to “send an email to a person” but it may not know how to do that yet. Normally, most computing systems will crash when this happens. In the system described herein, when such an unforeseen event happens the system does not crash, but asks a human/machine to supply the missing logic/code that can be used to execute the action, e.g., as shown in FIG. 13D. Here, the main idea to make this happen is to run the steps in a dynamic execution environment like an interpreter which allows new code to be added to the system while the system is running. Now, traditionally this has been difficult because inserting new code itself is not sufficient. The caller of the new code needs to comply with the format in which the new code desires to be called. That includes providing the right set of input parameters. That involves deeper changes in the current steps and is very difficult. However, making use of the ability of the system to ask for parameters as it needs them from the caller in an interactive manner (as discussed above), permits new logic to be inserted into a currently running procedure. FIG. 13E shows an example of the logic being supplied by a further delegated human or machine.

As illustrated in FIG. 13F, some embodiments address the class of errors where the steps get executed with either wrong data or wrong logic/code. This class of errors is spotted in some embodiments only after the fact. In current state-of-the-art, there is no easy way to recover or retry from these errors. FIG. 13F shows that in the first run through the procedure steps 1 through 4 were executed, but Steps 3 and 4 were executed with the wrong data or logic. Hence, one approach is to rewind back to step 2, fix the data/logic and redo Step 3 and Step 4. The proposed system allows the developer to rewind to a given step in a previously run procedure, change the data and/or logic/code and then resume the procedure from that point onwards. If “undo” steps are known for the step3 and 4, then will be executed prior to the re-execution of the modified steps 3 and 4. In a simpler case, the failing statement could be an assertion or invariant that failed due to bad data or bad logic. The proposed system allows one or more replacement statements to be supplied that fix the bad data and/or code and then continue to execute other steps beyond the failed statement.

There are also errors that emanate neither from the data or code, but rather from the environment. For example, a procedure might fail because an external service became unresponsive for some time, or a computer hardware failed. In these cases, current state-of-the-art cannot do much, and normally system support personnel come and execute some recovery procedures. The system in some embodiments handles these cases in an intelligent manner. Whenever an environmental error is detected, the system reaches out to an error handling machine. The machine looks at the current error's signature and suggests running one or more recovery procedures, which if successful, trigger a reattempt from the failed step in the main procedure. If the machine does not have enough experience with this kind of error, it forwards the issue to a human subject matter expert. The human provides a potential fix, which the machine tries. If the fix works, the machine remembers the mapping between the error signature and the fix that worked. This allows it to self-service future similar errors. Over time the machine becomes intelligent enough to handle many error scenarios. This mapping of errors to potential recovery procedures can be done using any classification technique including but not limited to deep neural networks. As shown in FIG. 13G, the error recovery steps A and B are executed and then Step 3 is re-attempted leading to Step4 and successful execution of the entire procedure.

As illustrated in FIG. 13F, some embodiments address the class of errors where the steps get executed with either wrong data or wrong logic/code. This class of errors is spotted in some cases only after the fact. In current state-of-the-art, there is no easy way to recover or retry from these errors. FIG. 13F shows that in the first run through the procedure steps 1 through 4 were executed, but Steps 3 and 4 were executed with the wrong data or logic. Hence, one approach is to rewind back to step 2, fix the data/logic and redo Step 3 and Step 4. The proposed system allows the developer to rewind to a given step in a previously run procedure, change the data and/or logic/code and then resume the procedure from that point onwards. If “undo” steps are known for the step3 and 4, then will be executed prior to the re-execution of the modified steps 3 and 4.

As illustrated in FIG. 13I, some embodiments address the class of situations where incomplete code was executed. This class of situations are sometimes errors and at other times are intentional. When the incompleteness of the code is unintentional, it is only after the fact that the error is discovered, usually by a human observing the record of what has been executed. In current state-of-the-art, there is no easy way to ask the machine to insert another step at the end of the incomplete run. FIG. 13I shows that in the first run through the procedure steps 1 through 4 were executed, and the system stopped after Step 4. The proposed system allows one to provide one or more new steps to be appended to the end of the completed run and ask the system to continue with the preserved state of the Step 4. This is made possible by the fact that the proposed system keeps the detailed trace information of the steps run even after the original steps finished. In most current computer systems, the details of the run are thrown away after the steps are completed rendering it impossible to append any new continuation logic after the first run has completed. As shown in 13I, a human or external system determines that some logic was missing, the new logic is obtained from an external system or a human and is inserted at the end of the prior run's logic. The system then resumes from where it had stopped and executes Step 5 and then stops, but can receive and execute more steps in a similar fashion.

In another embodiment of the system, the system is capable of learning how to answer arbitrary questions (not just the questions around error handling as seen in the previous sections). To permit this, the question is expressed in a format, a preferred embodiment of which is shown in FIG. 9, although other formats including natural language formats could be used. Whenever, there is a question during the execution of a procedure, the question is forwarded to the question handling layer (as shown in FIG. 13H). The question handling layer then forwards the question to the learning service which looks into its database for matching answers. If there is a matching answer found, then the learning service forwards the answer to the question handling layer which then processes the answer and then retries from the step that was waiting for the answer. In the other case, where the learning service does not have a matching answer, the learning service forwards the question to a subject matter expert which could be a human or a machine that understands the question and its structure. The human or machine can give an answer which the question handling layer uses. In this case, when the answer is deemed as useful, the question handling layer teaches the learning service the answer for future reference.

Any suitable question format may be used in embodiments of the invention. The question type (Qtype) pertains to the type of question that may be posed (e.g., when, where, how, what, why questions). The question path (Qpath) pertains to the path that describes the object of interest. (e.g., if one is looking for the capital of a country, then the qtype is “what” and the path is “the capital”).

The question may be in any number or types of context. The following is an example list of contexts of the certain types, where each context has more detailed information identifying the situation in which the question was asked. (1) subject context, where this context contains the subject about which the question is asked, can be an ID or name of the subject, with details of the relationship of the subject with other relevant entities (like John, son of Adam, grandson of Bob), and/or each entity also carries type information. (like John-a person, Adam-a person, Bob-a person); (2) procedure context, where this context contains the procedure/code/logic that was being run when the question arose, and typically this will refer to the step number in a named procedure; that procedure may further be embedded in another procedure and so on; (3) user context, where this context records the humans or machines involved in the process when the question arose, e.g., the user who invoked the procedure and the user who wrote the procedure can be captured in this context; (4) time context, where this context captures the exact time when the question arose, and also captures duration information which could be more flexible like “on Monday”, “every day after 5 pm”, “at noon”, “every leap year on January 1”; (5) location context, where this context captures the location where the parties of interest are at the time the question arose, e.g., the location of the machine running the process and the location of all the users in the user context can be represented in this context; and/or (6) system context, which pertains to the ID of the system which asked the question.

“Rejected answers” pertain to answers to the question that have already been rejected. “Rejected answer recipes” pertain to logic/code that were earlier proposed to find the answer, but have been rejected. “Validations” pertain to conditions that must be met before accepting any answer. For example, date must have certain formats, Age must be selected from a range, Password must have a digit and a special character. “Delegates” pertain to a list of users who have been asked this question. “WaitPolicy” pertains to how long will the system asking the question wait before deciding to move on (either ask someone else or fail the step).

Answers may be provided by any suitable source or technique. For example, a user may be the source of an answer to a question. When a user is answering a question, the user can specify what subset of the contexts need to match for the answer to be considered applicable. For example, the user can provide an answer while keeping all the contexts, but removing the time context. That would mean that independent of what time it is, the answer is applicable as long as all the other contexts match. The user can also reduce the specificity of the contexts like location, user, procedure and even subject and thereby broaden the applicability of the answer. If the user removes the systemID, it makes the answer applicable to all systems.

In some embodiments, a machine that understands the question structure could answer the question instead of a user. An AI-based machine can be employed in conjunction with a knowledgebase to provide the answer. In some embodiments, an LLM may be used to provide an answer.

The user and/or machine can also delegate the question to another entity. For example, the user/machine can simply delegate the question to some other user(s) and/or machine with or without some additional validations and the learning service will learn to delegate as a response.

A learning service can be used to provide the answer. Based on the qtype (question type)), qpath (question path), and/or contexts of the question, the learning service can determine which prior answers are an exact match and/or closest matches to the question. When an exact match is not found, the closest match could be found using heuristics involving a distance between the context of the question that the answer answers and the current question. Deep neural networks can also be used to determine the best matching answer for a given question.

Crowdsourcing can also be used to provide the answer. The learning service stores answers learned with the system identifier (systemID) as one of the contexts. When there is no answer with a matching systemID, the learning service can refer to answers from other systems. To provide for privacy, in a preferred embodiment, the learning service will only use answers from other systems if they belong to the same organization/user or the answer is fairly common among systems and thus is not identifying the other systems in any way (this is how autocomplete works when one types in emails and/or search bars).

This disclosure will now describe an approach to pass a parameter in natural language to a procedure in a native language. In computer science, work is done in units of computation called functions, methods or procedures. Each such procedure can be composed of simple statements or calls to invoke other procedures. The normal way of passing information from the calling procedure to the called procedure is by using “parameters” or “arguments”. Computer languages use procedure declaration and invocation logic (the Python language is used here as an example, but all other languages use similar constructs).

The procedure is declared as “def my_procedure (my_arg1: int, my_arg2: str)”. The invocation of the procedure is done as follows in an example:

```
def caller_procedure( ):
  some_number = 21
  some_string = “foo”
  another_string = “bar”
  my_procedure(some_number, some_string)
```

It is noted that if it turns out during the execution of the procedure “my_procedure” that it needs access to another piece of information from the caller procedure (for example ‘another_string’), then it cannot be done at runtime because the definitions will have to change and the code will have to be recompiled, which implies restarting the program.

Some embodiments provide an approach to pass information from the calling procedure to the called procedure. Instead of the information being passed into the called procedure, the called procedure pulls information from a shared knowledge graph. This is strictly more powerful than the traditional approach because it allows the called procedure to have access to all of the information in the knowledge graph without up-front deciding what that needed information might be. However, sometimes, even the knowledge graph may not have the information. Normally, in a computer, this would result in an exception that would normally terminate the program. However, in the current system, this allows the missing information to be furnished to the called procedure by an external system or human while the called procedure waits for the information.

In some embodiments, the natural language procedure may modify a knowledge graph before invoking the native language procedure. The native language procedure invokes a special function to retrieve parameters, where the special function first looks up a knowledge graph for the parameter, and the special function then looks up an external program/service or asks a human for the parameter. The native language procedure may obtain access to parts of speech concepts in natural language by looking up using special names like ‘subject’, ‘object’, ‘preposition’, etc.

There are many benefits of this approach. Firstly, the calling procedure does not have to change when the called procedure is changed requiring more information. This is because information is pulled from the called procedure instead of being passed into the called procedure. Secondly, when information is not available in the knowledge graph (for example, the password to access a system), the procedure does not crash like a normal computer program would. Instead it waits for human input and once the input is obtained, the called procedure proceeds as if the information was there in the knowledge graph. The benefit of this is that procedures do not crash because of missing information requiring a human to not only remedy the missing information but also figure out how to restart the failed procedure after cleaning up for the steps that happened before the failure.

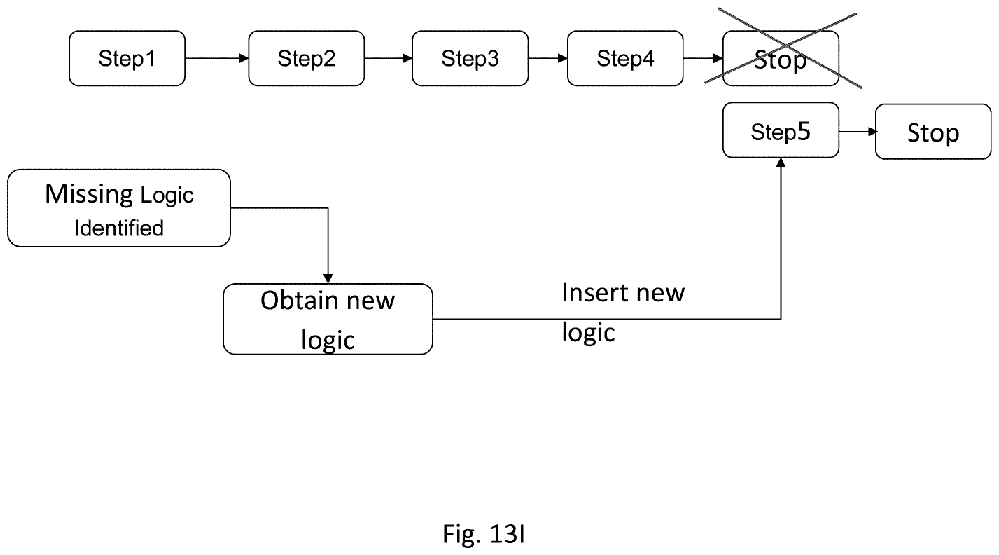

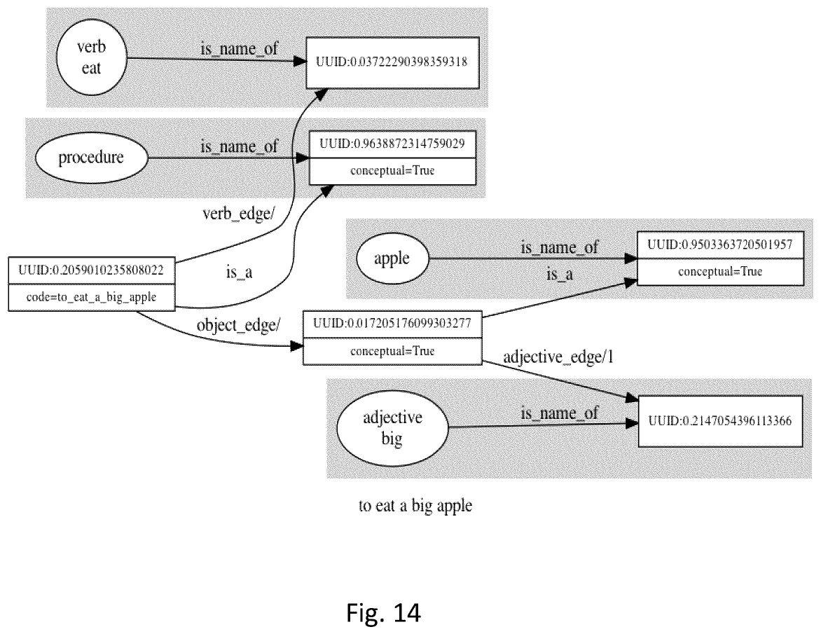

Some embodiments of the invention pertain to approaches that rely upon resolution of procedures. As part of processing a natural language command as discussed previously at step 804 of FIG. 8, searching is performed for the procedure to run. Procedures are kept in the knowledge graph in some embodiments. The following is a list of some example procedure types: (1) Proper noun procedures; (2) Common noun procedures; (3) Adjective procedures; (4) Preposition procedures; and/or (5) General procedures. A proper noun procedure is a procedure that returns a representation of the proper noun by running some native computer code. For example, “salesforce is <code>” when executed will run the specified code which returns a native representation of the proper noun “salesforce”. That native representation could have methods to get further properties of “salesforce” or might have some metadata like the username, password and/or location of “salesforce”. Such a procedure and its code are represented in the knowledge graph as a vertex which has the code as one of its properties. A common noun procedure when executed could return instances of the common noun. For example, “the employees are <code>”. When the code is executed, it returns a list of representations of employees. Just like proper nouns, a common noun and its code is stored as a vertex in the knowledge graph. Adjective procedures specify the logic that is used to determine if a noun satisfies the adjective or not. For example, “a number is odd if <code>”. Here, to determine if a number is odd or not, the given code is run and based on whether it returns True or False, the determination is done as to whether the number is odd or not. The code is stored in a vertex that represents “an odd number” in the knowledge graph. Similarly, a prepositional procedure is used to determine if a noun satisfies a preposition. For example, “a word is in a message if <code>”. Here to determine if the word is in the message, the code is run, and just like in the adjective case, the result determines if the preposition is satisfied or not. General procedures are more flexible. It represents code that corresponds to any imperative statement of natural language. For example, “to send an email to a person <code>”, provides the code to be executed any time the system needs to send an email to any person. The represent this information in the knowledge graph, a vertex is created which has the code as one of its values. To encode the phrase “to send an email to a person”, the parts of the speech in the phrase are extracted. In this case, they are “verb=send”, “object=an email”, “preposition=to a person”. Then these parts of speech are encoded in the knowledge graph via graph edges emanating from the vertex to the vertices in the knowledge graph that represent each of the concepts in the parts of speech. An example of such a vertex and its relations to parts of speech concepts in the knowledge graph is shown in FIG. 14 which depicts a procedure “to eat a big apple <code>”. The code is contained in the concept which has “code=to_eat_a_big_apple”. There is a verb edge from that concept to the verb concept whose name is “eat”. There is an object edge to a concept which represents a big apple (the concept is an apple and is big). Thus, the vertex represents “to eat a big apple” and stores the code to do so.

The need to resolve a procedure arises in one or more of the following ways: (a) Via Noun resolution; (b) Via Adjective resolution; (c) Via Preposition resolution; and/or (d) Via an imperative action clause.

With regards to computing a proper noun, proper nouns are complex entities and thus if they have a procedure attached to them it invariably returns functions used to resolve child concepts under the proper noun.

With regards to computing a common noun instance, when a child relation of a vertex is being looked up, the system first attempts to compute the child instance. To determine if there exists a procedure to compute the child, one can look at all equivalent vertices of the child vertex in the brain graph and run any code available in the nearest equivalent vertex. If no such code is obtained rendering the child uncomputable, the system can resort to searching in the brain graph for the child as a second measure. If that also fails, then the system looks for any domain-specific resolvers that are applicable and execute appropriate methods from the domain. Failing this, a realization can be made that the child cannot be obtained and either reach out to the user or create a placeholder for the child based on the field type of the noun being computed.

When computing an adjective, when determining if a concept in the brain has an adjective, one can first see if there exists a procedure to compute the value of the adjective. If yes, then run the code to determine the value. If no, then search the brain graph to determine whether the adjective is true for the subject concept.

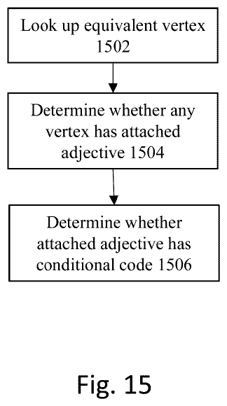

FIG. 15 shows a flowchart of an approach to look up a procedure. At 1502, the processing looks up the equivalent vertices of the subject vertex. At 1504, a determination is made whether the vertex has the adjective attached to it. If so, then the subject vertex has the adjective. At 1506, a determination is made whether the attached adjective vertex has a conditional code. If so, then that is run to determine whether the subject vertex has the adjective or not.

With regards to computing a preposition, this can be resolved similar to the adjective case by looking for the concept in the knowledge graph that corresponds to the preposition and executing the code that is part of the concept.

With regards to resolving an imperative action clause, each action clause has a list of resolved nouns as concepts corresponding to the parts of speech in the clause. That map of concepts can be referred to as the “i_concept_map”. The right procedure to execute is chosen based on one or more of the following rules: (1) The procedure should have edges corresponding to each part of speech concept in the i_concept_map; (2) The edges should point to a vertex that is equivalent (defined above) to the concept in the i_concept_map; (3) If multiple procedures match, use the most precise procedure which is the procedure whose edges point to the least general vertices. Inheritance applies to all nouns and the more precise vertex is preferred, e.g., John is more precise than “a man”, and “a man” is more precise than “a living thing”; (4) if a part of speech is plural, prefer matching a procedure that has an edge pointing to a plural vertex that is equivalent to it, where failing this, break up the instances in the plural concept to a list of singulars, and then look for a matching procedure that is then applied to all the singulars individually, e.g., for “send the emails”, where the system prefers a procedure that has edges to “send” and “emails” and failing that, look for the procedure which has edges to “send” and “an email”, and then invoke the procedure for each email that was matches with “the emails”; (5) procedures that are defined within other procedures or environments are not allowed to match outside of their definition scope, where the system allows procedures to be available only within the scope of a parent procedure, e.g., “to order a pizza” could be qualified as “while in San Jose” environment, or within “to arrange a birthday party” procedure, and all else being the same, the procedure that is closest (in lexical depth) to the invocation point is chosen; (6) if multiple matching procedures are found, then the user is asked to guide as to which one should be used, and once the user provides the answer, the processing resumes; (7) if zero matching procedures are found, then the user is asked to provide new logic/procedure to learn, and once the user provides the logic, the processing resumes.

With regards to equivalency of vertices, this approach captures a generalized form of object inheritance as defined in OO (object oriented) languages. For any vertex, the following are equivalent to it in order of precedence: (1) Self; (2) Self's cousins; (3) Self's base classes, where a base class should have the same or fewer adjectives/prepositions (making it a base class). It cannot have an adjective/preposition that self does not have.

A cousin is a vertex that is a child of a vertex that is equivalent to one of self's parents. This is a recursive definition, so there can be second cousins, third cousins, etc. For example, if self has a parent vertex (<parent>) with a relation r/<rel> to it, then if <parent>-c/<rel>→(equiv) exists, then equiv is equivalent (1st cousin) to self. However, (equiv) must have the same or a subset of the adjectives/prepositions that self has. And if <grandparent>- - - r/<rel1>- ->parent - - - r/<rel2>→(self) is equivalent to <grandparent>- - - c/<rel1>- ->parent - - - c/<rel2>→(equiv), then it is equivalent as well. This is done recursively and hence adjectives/prepositions are taken care of at each level. Note that a relation starting with “r/” indicates a relation to an instance of a class, where a relation starting with “c/” indicates a relation to a class.

Some embodiments of the invention provide an approach to define procedures (in natural or native language) to determine if a concept satisfies an adjective, and to use the adjective in natural language sentences in a natural language program.

In normal natural language, one uses adjectives as a way of filtering and selecting based on which entities satisfy the property. For example, while “all cars” implies that one is talking about all possible cars, “all red cars” narrows down the selection to only the red cars. Further “all old red cars” narrows it down further to the red cars that are also old. Natural language is very concise in this aspect where filtering down a set of entities based on a property can be done by the mere introduction of a single adjective.

By contrast, most computer languages do not have such conciseness or readability when doing filtering. For example, in Python, “all red cars” would be expressed as: [c for c in cars if car.color==“Red”]. Not only is this expression verbose, but it may also be unintelligible to a non-programmer.

Some embodiments are directed to an approach to provide the conciseness and clarity of natural language adjectives into a programming language paradigm. To determine whether a car is red could be a simple procedure or it could involve a deeper computation (for example figuring out if a car is old may require comparison of dates). This logic that determines whether an entity satisfies an adjective can be expressed in a native computer language or in natural language. However, independent of how the adjective determination is done, the usage of the adjective can be done in the same way in the natural language program as shown in FIG. 9D and FIG. 11D. Any time the natural language interpreter processes an adjective, it looks up its knowledge graph to see if there is a procedure to determine if an object of the right type (car or number) is the given adjective (red or prime or divisible). If there exists a procedure, then the interpreter runs that procedure using the right execution engine (Python, javascript or natural language interpreter itself). Based on the answer obtained at the end of running the procedure, the interpreter decides whether the object of interest satisfies the given adjective or not, and based on that does the appropriate filtering. An example of such filtering can be seen in the FIG. 11D where out of all the numbers from 2 to 20 only the prime numbers were obtained by filtering out the prime numbers using the procedure that determines if a number is prime.

This disclosure will now describe an approach to resolve nouns according to some embodiments of the invention. A noun is a phrase that points to something that can act as a subject or object of a verb or is the subject of an expression. The following are examples of subject, object, or prepositional target nouns in facts: Subjects are shown in double quotes, objects in single quotes and prepositional targets can be underlined for clarity: (a) “John” is ‘a person’; (b) “John's age” is 21; (c) “John's red car” which is in the garage is broken (where the words “the garage” can be underlined); (d) “John's red car's deflated tire” whose air pressure is 21; (e) “the bank account number” is 1234. The following are further examples within expressions that are computed: (a) “John's age”; (b) “John's car” which is in the garage (where the words “the garage” can be underlined); (c) “the even number”+“the odd number”. As discussed in more detail below, based on the type of clause and sometimes the role of the noun in the clause, the system assigns a field_type to the noun. The field_type is subsequently used in resolving the noun to a new/existing concept in the brain graph, or a new/existing concept in the stack.

Regarding a structure for how nouns are resolved, it is noted that the engine (brain) stores concepts in two places: (i) the knowledge graph, (ii) the context trace. The knowledge graph or the brain graph is a representation of the facts that the brain knows. It can be stored in a graph database or a simpler key-value database or simply in memory. The context trace is a representation of what the brain has executed and is similar in concept to what a “stack trace” is in a traditional computer system. However, the big difference is that the system keeps the contexts (or stack frames) around even after the procedure finishes, whereas, most systems will unroll the stack and delete the data that was in the stack frame after the procedure is done. The context trace is a hierarchical structure. Each context has 0 or more sentences. Each sentence in turn can have 0 or more contexts. Each sentence represents one natural language command or an invocation of a native language procedure.

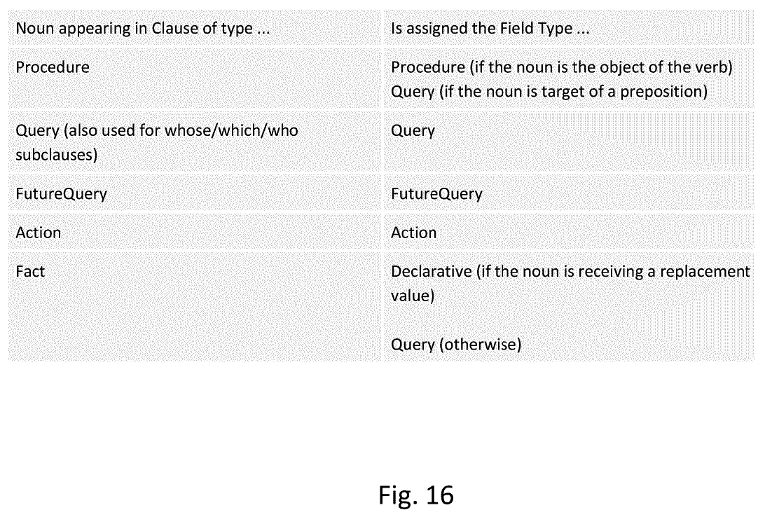

Whenever a sub procedure is run, the sentence structure also stores what is called a POS (part of speech) map of the concepts in the sentence that the brain determines are needed by the called procedure. The first step is to examine the type of the clause (or sentence) that is running. The parser is able to determine the clause type based on natural language processing using AI. The second step is to examine each noun in the AST and determine the Field Type for the noun based on the clause type of the sentence. This mapping is provided in FIG. 16. The third step is for each noun to be resolved, based on the field type looked at in the corresponding table of resolution algorithms to use.

With regards to detecting and handling of exceptions, when resolving a concept using a resolution algorithm, the system attempts each step in the resolution algorithm. If a match is not found, the resolution algorithm detects the exception and then suggests the action to take. The action could be to ask the user, to create a new concept in the knowledge graph, or to ignore the exception and carry on. When the action is to ask a user, the resolution algorithm pauses the execution of the procedure that was attempting to resolve the noun. This causes the system to reach out to the user or an external system to get the missing value or missing logic that can furnish the value. Once that information is obtained, the system re-evaluates the nouns in the command being executed and this time around, the resolution algorithm gets the answer either directly from the knowledge graph or by computing the value, and then the overall procedure resumes from where it had stopped.

A clause is something that has a subject and a predicate. In action clauses the subject is the implied ‘you’ and thus not explicitly mentioned. The following are example types of clauses: (a) action; (b) fact; (c) query; (d) future query; and/or (e) procedure.

Some examples of action clauses are (shown in double quotes): (a) “run”; (b) “send the email”; (c) if the email is received then “say ‘received’”.

Some examples of fact clauses are (shown in double quotes): (a) “John's age is 21”; (b) “a number is even if the number is not odd”.

Some examples of query clauses are (shows in double quotes): (a) “John's age”; (b) is 43 prime; (c) if “the email is big” then say ‘big’; (d) send the employee “who is sick”; (e) delete the database “which is corrupted”.

An example of a future query clause is (shown in double quotes): whenever “John's age is 21” say ‘happy birthday’.

An example of a procedure clause is (shown in double quotes): “to send an email” say ‘hi’.

As noted above, based on the type of clause and sometimes the role of the noun in the clause, one can assign a field_type to the noun. The field_type is subsequently used in resolving the noun to a new/existing concept in the brain graph, or a new/existing concept in the stack by using an appropriate algorithm for resolving the noun.

FIG. 16 provides an illustration of a table that correlates a noun appearing in a clause of a certain type, which is assigned to a given field type. This table therefore describes example approaches to resolve nouns in clauses to field types.

One particularly interesting case is regarding facts. Facts can have two types of nouns: declarative and query. Declarative nouns receive a replacement value, whereas query nouns receive a qualifying property (adjectives, prepositions, and is_a relation). For example, “The mail is the context”. “The mail” is Declarative, and “the context” is a query. In “The mail is received.”, “the mail” is a query because more information is added to the LHS, which should already be defined. In “The mail's body is long.”, “The mail's body” is a query. In “The mail's body is the context.”, “The mail's body” is Declarative.

Some embodiments define algorithms to resolve fields which will be used to define the resolution behavior for the different field types. With regards to resolution algorithms, any step (going from a noun to a related noun), is performed using one of the resolution algorithm types described below. Resolution is essentially a sequence of places to look for the concept, and if not there what to do about it (declare something new, ask the user, or ignore and continue).

For a resolution pertaining to “StackDeclareFactInstance”, the algorithm performs (1) Look for matches from the POS (parts of speech provided while calling the enclosing procedure); For example, if “sent ‘hi’ to John” is invoked, and the procedure that is called is called “to send a message to a person”, then, in the POS map, “the message” will map to ‘hi’ and “the person” will map to John. Such a POS map is created any time a procedure is called, and in this step the system can look up the POS map, and (2) Create an uninitialized instance (A singular or plural concept) on the stack and return.

For a resolution pertaining to “StackDeclareInstance”, the algorithm performs: (1) If the concept is expressed as “the . . . ” (as opposed to “a . . . ”): Look for matches in the concepts that were introduced in the sentences or steps executed before this step. The sentences leading up to the sentence being executed are called “context sentences”. The system can look in the reverse order starting from the current statement working backwards to find the nearest sentence or step where the concept (e.g. the person) was introduced; (2) If the concept is expressed as “the . . . ”: Look for matches from the POS as described above; (3) Create an uninitialized instance (singular or plural on the stack and return.

For a resolution pertaining to “StackQueryInstance”, the algorithm performs: (1) Look for matches in the context sentences (as defined above); (2) Look for matches from the POS; (3) Ask the user if the system should create an instance. The processing may also ask for the value if relevant.

For a resolution pertaining to “DeclareInstance”, the algorithm performs: (1) Look for matches (of all adjectives, prepositions, whose/which clauses) in the knowledge graph; (2) If 0 found: Create the uninitialized child instance (real singular concept) or proper noun vertex and return; (3) If 1 found: return it; (4) If >1 found, ask user which one or if the user says so, create a new one.

For a resolution pertaining to “DeclareClass”, the algorithm performs (1) Look for matches in the brain graph; (2) Create the conceptual vertex and return.

For a resolution pertaining to “OptQuery Instance”, the algorithm performs: (1) Compute if possible; (2) Look for matches (of all adjectives, prepositions, whose/which clauses) in the brain graph. If the class itself is not known, ask the user before creating one; (3) If 0 found: Return NotEnoughInformation; (4) If 1 found: return it; (5) If >1 found, ask user which one if looking for one (“the”); Return all if looking for “any” or “all”

For a resolution pertaining to “QueryInstance”, the algorithm performs: (1) Compute if possible; (2) Look for matches (of all adjectives, prepositions, whose/which clauses) in the brain graph. If the class itself is not known, ask the user before creating one; (3) If 0 found: ask the user to provide the instance; (4) If 1 found: return it; (5) If >1 found, ask user which one if looking for one (“the”/proper noun); return all if looking for “any” or “all”.

For a resolution pertaining to QueryClass”, the algorithm performs: (1) Look for matches in the brain graph; (2) Ask the user to provide the class.

For a resolution pertaining to handling of the word “of”, consider that the X of Y⇒(is the same as) Y's X and an X of Y⇒Y's (conceptual X). For example, “the car of John⇒(is the same as) John's car” and “a car of the mayor⇒the mayor's (conceptual) car”. Here the word “conceptual” is a hidden marker on the word “car”. Also consider that “the X of the [Y's]*<noun>”==>(is the same as) “the [Y's]*<noun>'s X” (where [ . . . ]* denotes 0 or more instances of Y's), e.g., the car of the mayor's son⇒the mayor's son's car. In addition, “the X1 of the X2 of the [Y's]*<noun>”==>“the [Y's]*<noun>'s X2's X1”, e.g. the car of the mayor of the state's capital⇒the state's capitol's mayor's car. The “X of a [Y's]*<noun>”==>“a [Y's]*<noun>'s X”, e.g., the car of a mayor of the state's capital⇒the state's capitol's (conceptual) mayor's car. Here the “mayor” is treated as the conceptual class. The car is thus also a conceptual child of the conceptual mayor. In addition: (a) the X1 of the X2 of a [Y's]*<noun>==>a [Y's]*<noun>'s X2's X1; (b) an X of the [Y's]*<noun>==>the [Y's]*<noun>'s (conceptual) X; (c) an X1 of the X2 of the [Y's]*<noun>==>the [Y's]*<noun>'s X2's (conceptual) X1; (d) an X1 of an X2 of the [Y's]*<noun>==>the [Y's]*<noun>'s (conceptual) X2's (conceptual) X1; (e) the X1 of an X2 of the [Y's]*<noun>==>the [Y's]*<noun>'s (conceptual) X2's X1.

For a resolution pertaining to handling of “whose/which/who”, e.g., the person whose salary is highest, the database which is full, or the person who is sick is absent. In a Query/Action/Declarative clause: all nouns in the whose/which/who clauses are resolved with the QueryFieldType. In a Future Query clause: all nouns in the whose/which/who clauses are resolved with the FutureQueryFieldType. In a Procedure clause: all nouns in the whose/which/who clauses are resolved with the ProcedureFieldType.

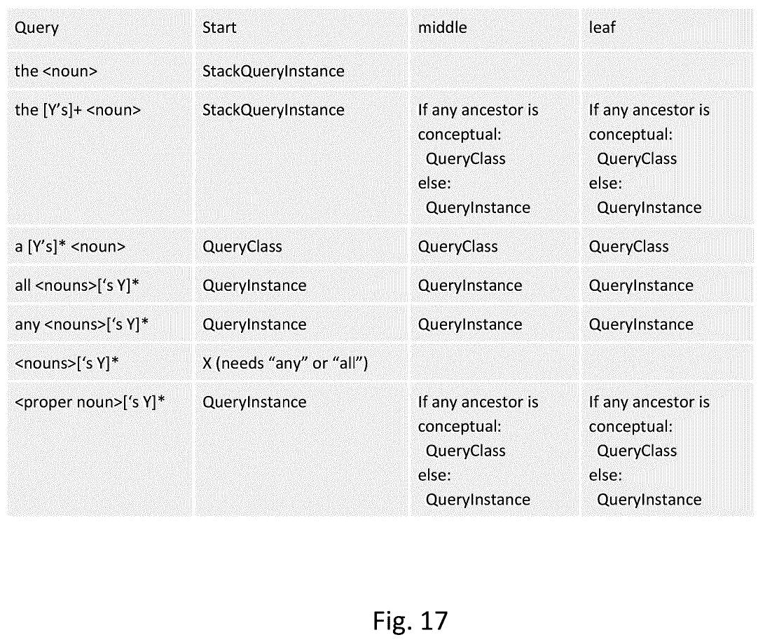

Regarding a query field type, the steps in the noun resolution of a field of query type involve StackQueryInstance, Query Instance and QueryClass algorithms. For the various types of noun phrases, one or more of these algorithms are applied based on the Table in FIG. 17. The Table has “start”, “middle” and “leaf” columns. In the example, “the chair's arm's color's code”, “the chair” is the “start”, “arm” and “color” are the middle, and “code” is the “leaf”. Thus, based on which part of a noun phrase is being resolved, the right column in the table is looked up to determine the applicable algorithm to use.

The Stack Query Instance approach performs: (1) Look for matches in the context sentences; (2) Look for matches from the POS; (3) Ask the user if the system should create an instance. The processing may also ask for the value if relevant.

The Query Instance approach is performed by: (1) Compute if possible; (2) Look for matches (of all adjectives, prepositions, whose/which clauses) in the brain graph. If the class itself is not known, ask the user before creating one; (3) If 0 found: ask the user to provide the instance; (4) If 1 found: return it; (5) If >1 found: Ask user which one if looking for one (“the”/proper noun). Return all if looking for “any” or “all”. E.g., if the employee's address is in New York then StackQuery Instance (“the employee”): Look for matches in the context and POS. If not found, ask user. Query Instance (“address”): Compute the address if possible. Look for address under the employee. If not found, ask user. QueryInstance (“new york”): The proper noun is looked up from the brain graph.

Regarding QueryClass, this is performed by: (1) Look for matches in the brain graph; (2) Ask the user to provide confirmation to create the class. “Is a dog furry” resolves “a dog”, where look for “a dog” is the brain graph. If not found, ask the user to provide confirmation to create the class. This is the QueryClass algorithm. “Is a dog's tail short”, resolves QueryClass (“a dog”), by looking for “a dog” in the brain graph. If not found, ask the user to provide confirmation to create the class. QueryClass (“tail”), looks for the class “tail” under the “a dog” node in the brain graph. If not found as the user to provide confirmation to create the class. “Is the tail of a dog short”, performed where QueryClass (“a dog”) looks for “a dog” is the brain graph, and if not found, ask the user to provide confirmation to create the class; and QueryClass (“tail”) looks for the class “tail” under the “a dog” node in the brain graph. If not found as the user to provide confirmation to create the class.

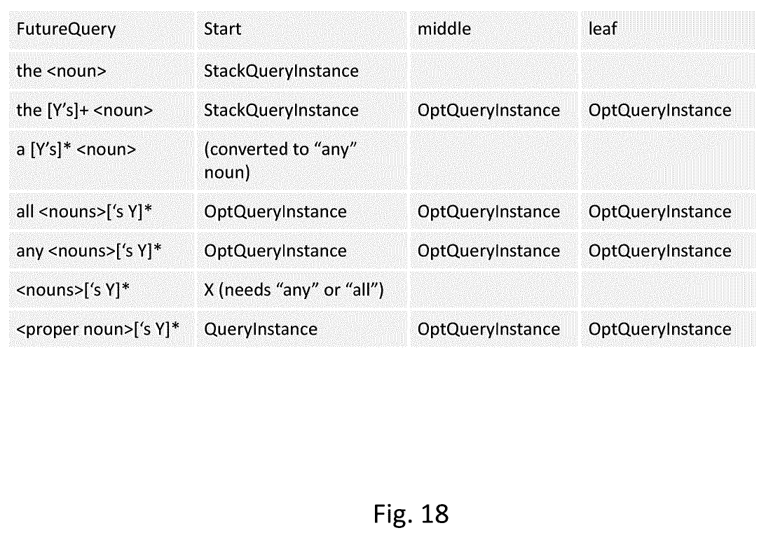

Regarding handling of the word “of”, the table shown in FIG. 17 provides that anywhere “an X of Y” is encountered it creates a conceptual child of Y. That conceptual child and all its children are processed with QueryClass algo. Different algorithms can be applied while resolving different parts of a complex noun. Regarding “Future Query Field Type”, the steps in the noun resolution of a field of future query type involve StackQueryInstance, OptQueryInstance and QueryInstance algorithms. For the various types of noun phrases one or more of these algorithms are applied based on the Table in FIG. 18.

For “StackQueryInstance”, this is performed by: (1) Look for matches (with all adjectives, prepositions, whose/which clauses) in the context sentences; (2) Look for matches (with all adjectives, prepositions) from the POS; (3) Ask the user if the system should create an instance. Ask for the value if relevant. E.g. “Whenever the number >10 . . . ”, this resolves “the number” by looking for “the number” in the context sentences. Look in the POS map (parts of speech map) of the enclosing procedure if any. Ask the user. This is the StackQueryInstance algo. For example, “Whenever the phone number of a person is deleted . . . ”, this treats “a person” as “any person”, which is resolved by querying for ‘all people’ and then running the boolean expression with each person instead of ‘a person’. If there are no people, the boolean is considered either false. To resolve ‘phone number’, this is resolved using OptQueryInstance algo as it is ok if the brain does not know what the phone number is.

For “OptQueryInstance”, this is performed by: (1) Compute if possible; (2) Look for matches (of all adjectives, prepositions, whose/which clauses) in the brain graph. If the class itself is not known, ask the user before creating one; (3) If 0 found: Return NotEnoughInformation; (4) If 1 found: return it; (5) If >1 found: Ask user which one if looking for one (“the”). Return all if looking for “any” or “all”. For “whenever the employee's address is in New York then . . . ”, the Stack QueryInstance (“the employee”) looks for matches in the context and POS. If not found, ask the user.

OptQueryInstance (“address”) computes the address if possible. Look for an address under the employee. If not found, return NotEnoughInformation and assume that the condition cannot be computed at this time.

For “Whenever a phone number of a person is deleted . . . ”, OptQuery Instance treats “a person” as “any person”, which is resolved by querying for ‘all people’ and then running the boolean expression with each person instead of ‘a person’. If there are no people, the boolean is considered false. If the brain does not know what a person is, it asks the user to define the class. If no people are there, then it does not bother to resolve the children (phone number). Hence if phone number is not known as a class, it won't bother the user at this stage. OptQueryInstance treats “a phone number” as “any phone number”. That is resolved by querying for “all phone numbers” of the particular person chosen in the first step's iteration. If there are no phone numbers, then the boolean is returned as False. If the system does not know what phone number means, then the Boolean will return None.

For QueryInstance, this is performed by: (1) Compute if possible; (2) Look for matches (of all adjectives, prepositions, whose/which clauses) in the brain graph. If the class itself is not known, ask the user before creating one; (3) If 0 found: ask the user to provide the instance; (4) If 1 found: return it; (5) If >1 found: Ask user which one if looking for one (“the”/proper noun). Return all if looking for “any” or “all”. Query Instance is used whenever a proper noun is encountered. For “whenever the employee's address is in new york then . . . ”, then QueryInstance (“new york”): is used where the proper noun is looked up from the brain graph. For “whenever john is late then . . . ”, then QueryInstance (“john”) is used where the proper noun is looked up from the brain graph.

For the handling of the word “of”, in the table shown in FIG. 18 table, anywhere “an X of Y” is encountered it creates a conceptual child of Y. That conceptual child and all its children are processed with OptQueryClass algo.

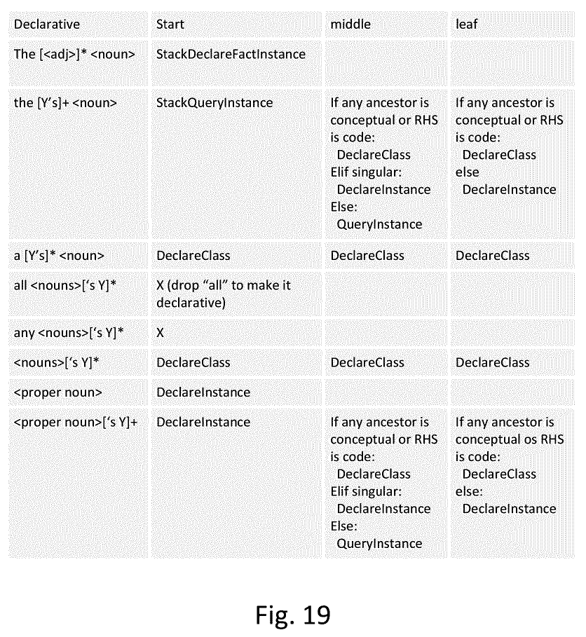

This disclosure will now discuss how to resolve a noun of the declarative field type. For the various types of noun phrases, one or more resolution algorithms are applied based on the Table in FIG. 19. The “DeclareInstance” approach is performed by: (1) If not conceptual (not “a”): Look for matches (of all adjectives, prepositions, whose/which clauses) in the brain graph; (2) If 0 found: Create the uninitialized child instance (real concept with all adjectives, prepositions, whose/which clauses) or proper noun vertex and return; (3) If 1 found: return it; (4) If >1 found: Ask user which one or if the user says so, create a new one. For “John is a person”, this is resolved by looking for John. If none, declare one. If 1, use it. If >1, ask user which one or new one. This is the DeclareInstance algorithm. For “John's age is 21”, this resolve john as above. To resolve age, look for age under John. If none, declare one. If 1, use it. If >1, ask user which one or new one. For “John's son is Adam”, this resolves john. To resolve son, look for son under John. If none, declare one. If 1, use it. If >1, ask user which one or new one.

“StackDeclareFactInstance” is handled by: (1) Look for matches from the POS (parts of speech provided while calling the enclosing procedure); (2) Create an uninitialized instance (singular or plural concept) on the stack and return. For “The number is 21”, this resolves ‘the number’ by looking for matches in the parts of speech in the enclosing procedure. Otherwise, declare a new variable on the stack. This is the StackDeclareFactInstance algorithm. For “The headcount is <code>”, resolve ‘the headcount’ by looking for matches in the parts of speech in the enclosing procedure. Otherwise, declare a new variable on the stack. Here RHS is code, so later when the assignment is done, the code will be assigned instead of a value. Whenever the value is needed the code will be executed. The system can define some caching policy in the future.

For “DeclareClass”, this is addressed by performing: (1) Look for matches in the brain graph; (2) Create the conceptual vertex and return.

Regarding the handling of the word “of”, in the table of FIG. 19, anywhere “an X of Y” is encountered it creates a conceptual child of Y. That conceptual child and all its children are processed with DeclareClass algorithm.

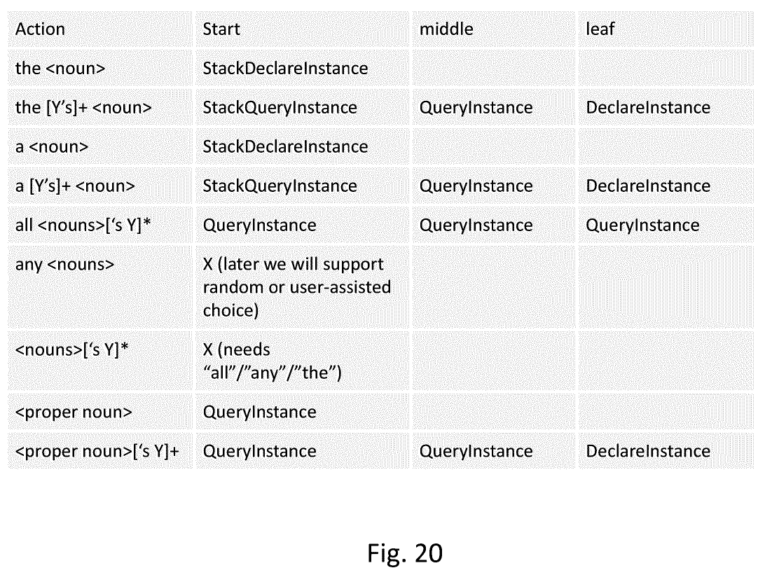

Regarding resolving a noun of the action field type, the StackDeclareInstance, Query Instance, DeclareInstance algorithms are used. For the various types of noun phrases one or more of these algorithms are applied according to the table in FIG. 20. “StackDeclareInstance” is performed by: (1) If “the . . . ”: Look for matches in the context sentences; (2) If “the . . . ”: Look for matches from the POS; (3) Create an uninitialized instance (singular or plural concept) on the stack and return.

In some embodiments, “Of a” is not supported whereas “Of the” is supported. In the table of FIG. 20, anywhere “an X of Y” is encountered it creates a conceptual child of Y. That conceptual child and all its children are processed with DeclareInstance algorithm.

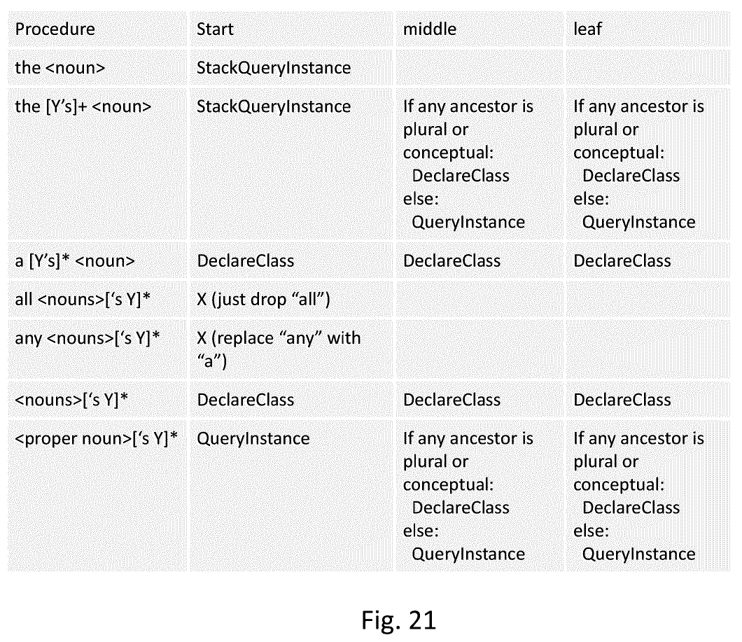

For a procedure field type, the steps in the noun resolution of a field of procedure type involves DeclareClass and StackQueryInstance, QueryInstance algorithms. For the various types of noun phrases one or more of these algorithms are applied according to the Table in FIG. 21. For “DeclareClass”, this is performed by: (1) Look for matches in the brain graph; (2) Create the conceptual vertex and return. For “StackQueryInstance”, this is performed by: (1) Look for matches in the context sentences; (2) Look for matches from the POS; (3) Ask the user if the system should create an instance. Ask for the value if relevant. For “Query Instance”, this is performed by: (1) Compute if possible; (2) Look for matches in the brain graph; (3) Ask the user to provide the instance.

In the table of FIG. 21, anywhere “an X of Y” is encountered it creates a conceptual child of Y. That conceptual child and all its children are processed with a DeclareClass algorithm.

This disclosure will now describe an approach according to some embodiments for implementing a natural language interpreter or compiler that can automatically produce a natural language trace of any natural language program it runs.

To explain, consider that computers are typically programmed using computer languages. Normally, when a computer runs a program written in a computer language, it does so without being able to explain back to a human what it did in a language that the human can readily understand. That is the reason when computer programmers want to debug a computer program, they often add “print” statements as part of the program in an effort to produce a trace of what happened at key points in the program. However, conventional computing/debugging technologies do not provide a computing system which eliminates the need for having these “print” statements by automatically generating trace commands in natural language for each step that the computer took while running the program.

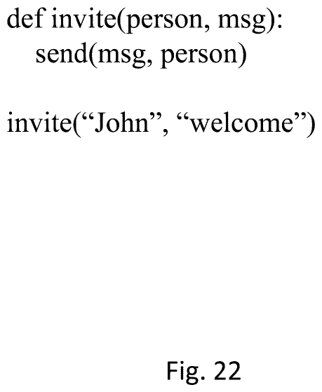

FIG. 22 shows a sample computer program written in Python. Now, a human (especially programmers) looking at this program may be able to guess what is happening, but when a computer is running the statement “send (msg, person)”, it does not have enough context to automatically translate that into a natural language explanation of what is happening. In fact, most compilers will strip out the symbol names for storage efficiency and also optimize away some statements, or reorder statements for computational efficiency. All the transformations that compilers perform renders it nearly impossible to general a meaningful explanation of what happened in a language that humans will understand. This is the reason that when programs crash, it is usually insufficient to look at the “dump” of the program, and developers usually resort to reproducing the problem while running step by step in a debugger where they can explicitly look at the state of the variables and infer what is happening. In cases where the luxury of debuggers is not available or it is too slow, the developers will add print statements in the program to create a more human readable trace of what happened. However, creating any human readable trace requires explicit instructions to be added to the original program and normally is only done where deemed necessary.

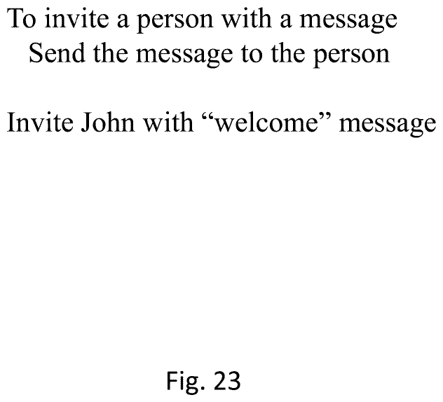

Now, consider the same program, but this time written in natural language as shown in FIG. 23. Here, most humans who do not know computer programming will still be able to explain what is meant by this program. A computer system capable of running such a natural language program is well positioned to be able to produce a human-intelligible natural language trace of what was executed. This disclosure will now examine how that is done for this program.

The first two lines “to invite . . . ” are teaching the computer how to invite a person. So, the computer simply writes a trace mentioning that it “learned how to invite a person with a message”. Note that since the program is in natural language, this permits creating a trace using that natural language.

Next the computer runs ‘Invite John with “welcome” message’. Here the computer realizes that it needs to run the procedure “to invite a person with a message” wherein, “a person” will map to “John” and “a message” will map to “welcome”. Thus, when “send the message to the person” is run, a trace of “send ‘welcome’ to John” is created by replacing the placeholders “the message” and the “the person” with the concrete values that were used during runtime.

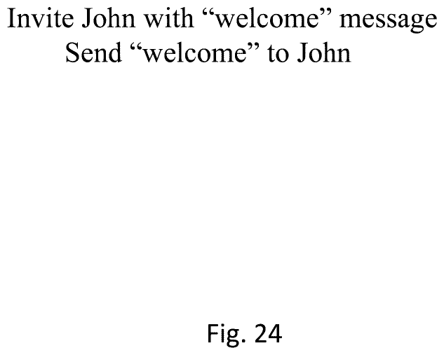

Hence that becomes the next trace which is nested under the first trace as shown in FIG. 24. In this manner, the system obtains a natural language human-readable trace for a computer program without the need for explicit “print” statements in the code.

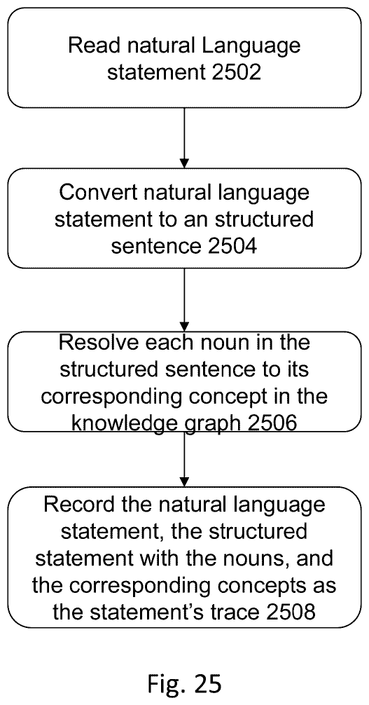

FIG. 25 provides an approach to implement recording of relevant information while executing natural language programs in order to facilitate natural language traces of the program at a subsequent time.

At 2502, the processing will read the natural language statement, and at 2504, will convert it to a structured sentence. A structured sentence can be of any format, like a JSON structure, an example of which is shown in Appendix 1 of U.S. Prov. Application No. 63/105,176, filed on Oct. 23, 2020, which is hereby incorporated by reference in its entirety.

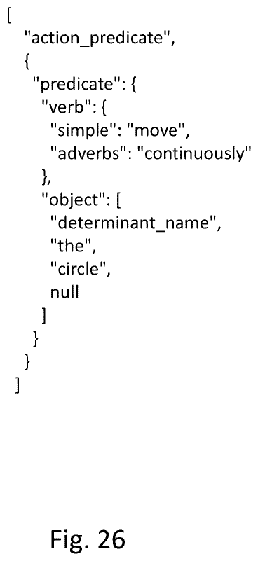

To explain, consider the natural language statement: “continuously move the circle”. FIG. 26 shows a structured sentence (AST) that can be derived from that natural language statement. There are many other ways to represent the sentence structure, but the main idea is to separate out the parts of speech and determine which nouns need to be resolved into instances. In the above example, “the circle” needs to be resolved into which instance of the circle it is referring to. As the system executes commands, it builds a knowledge graph and in the example, “the circle” refers to a circle in “the scene” introduced previously in the program. As noted at step 2506, each noun is resolved in the structured sentence. This resolution of nouns based on the nouns that have been seen earlier in the program and/or are part of the knowledge graph is described above with regards to noun resolution.

Once the mapping from the natural language nouns (for example, “the circle”) to the corresponding instances (an internal reference or an ID of the instance of the circle) is done, the natural language statement is executed. The trace consisting of the original natural language statement, the structured statement (AST), and the resolved nouns, is stored by the system in a database or file (2508).

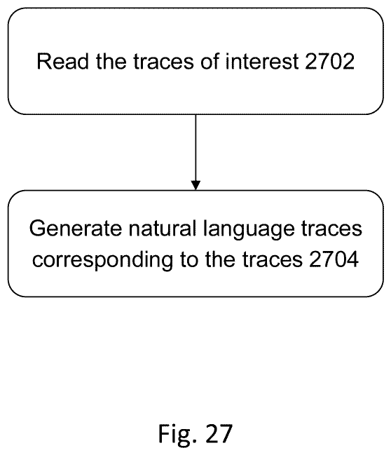

FIG. 27 provides an illustration of a flowchart of processing for traces according to some embodiments of the invention. At a certain point time, when a natural language trace of a portion of the execution of the program is required to be presented, the system refers to the trace (e.g., reads the trace of interest at step 2702) and uses the structured statement and the resolved nouns to generate concrete natural language statements at step 2704. Concrete natural language statements are statements which replace the nouns with determiners with actual instances. For example, “send the file to the employee” is not concrete. However, “send ‘statement.pdf’ to John” is concrete. To do this the system replaces the nouns in the structured statement (AST) with the concrete values, and then converts from the structures AST to a natural language statement.

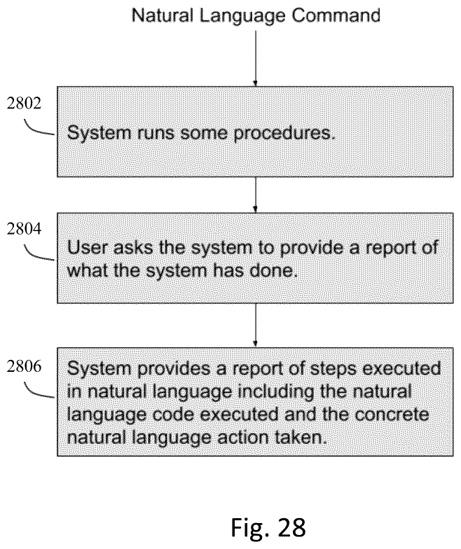

Therefore, the invention provides a significant advancement in the field of programming in the ability to explain what has happened in natural language back to the user. The system is able to answer any question about its decisions and the path it has taken so far in plain natural language. In FIG. 28, at 2802, the system may engage in the running of a given procedure. At 2804, the user may ask the system to provide a report of what has occurred. At 2806, the system provides the report as a sequence of natural language steps, as described above.

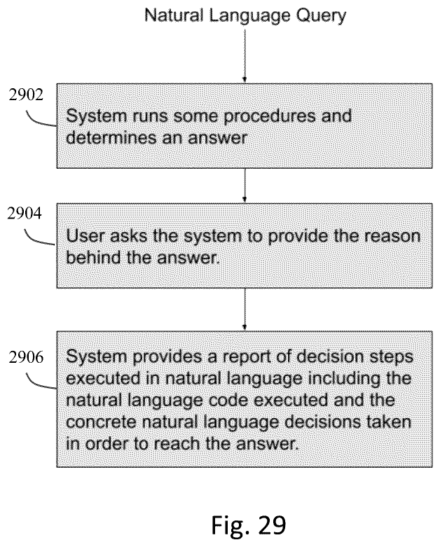

FIG. 29 shows a flowchart of a sequence of steps according to some embodiments which permits a user to understand the decision steps taken by the system. At 2902, the system may engage in the running of a given procedure, and an answer may be determined by the system. At 2904, the user may ask the system to provide a statement of the reasons for the answer that is provided. At 2906, the system provides a report of the decision steps that were taken to the user. The report may be in a natural language format, and may include a list of the natural language code that was executed to achieve the answer.

These advancements in explainability allow the user to better understand what happened in the system. For example, the user can ask ‘how many times did you send an email to John this month’, or simply ‘what happened’ or ‘why’. In addition, this approach allows the user to better identify faults in the programming that may have caused bad behavior. If there is a logic error in the program, seeing a trace of what happened in plain English is the best way to figure out what went wrong. This is not possible in the state of the art as most systems will give a stack-trace of code which is quite un-intuitive for a non-programmer. Furthermore, this approach allows for a change and restart of the program from a point in the past (but not necessarily all the way to the beginning of the task at hand). For example, if the command was to look for something in a house, when the system returns without anything found, the user may instruct the system to go back a few steps and retry after modifying a few commands (for example, opening the vault as well).

These capabilities are made possible by having the system record how everything it computes as it goes about processing statements. It not only records what commands were run, but it also records the current context at the time the commands were run. The system also remembers the old values of any values it overwrites. The system is able to translate any statement it executed into concrete terms. For example, the command “the number is prime” in the above example, when executed is not only recorded as the statement above, but also is recorded with the concrete number in place “41 is prime”. In another embodiment, the concrete version is computed only when demanded and only the mapping from “the number” to “41” is stored. To make the action of reverting some steps and retrying more accurately possible, the user can also teach the system how to “undo” certain operations. For example, the user can define two procedures, “to move an object . . . ” and “to unmove an object” or the user can use another syntax to describe the equivalent logic like “to move an object . . . to revert . . . ”. Whenever such revert capability is available, the system uses that when the user wants to revert to an older state.

### Use History of Persisted Facts to Improve Automation Accuracy and Create Dynamic Dashboards

This document describes a method to raise the accuracy of automation runs to detect anomalies in facts generated at every step.

An automation is a set of sequential steps run repeatedly on demand. The inputs and per step generated data (called facts) are different across automation runs. According to some embodiments, automation accuracy can be defined as ratio of: (Runs with correct results)/(Total number of runs with results).

There can be instances when the generated facts are incorrect. For example, consider the case where invoice number “102345” (ending in the number “5”) is incorrectly read as “10234S” (ending in the letter “S”), e.g., due to incorrect OCR extraction or bug in software. Such inaccuracies can manifest downstream, e.g., when users want to tally invoices against bank payments. Today, this type of error is detected after the incorrect value makes its way through the business. In current software automation processes, a low accuracy rate can cause significant loss of time and money to trace back the source of the error and make the necessary corrections.

This document describes a method to raise the accuracy of automation runs to detect anomalies in facts generated at every step. Since the automation system records information about each and every step in an automation, that recorded information can be used to identify anomalies within the automation process and/or the facts that are operated upon or produced by the automation process. This provides significant operational and performance advantages to users of such systems.

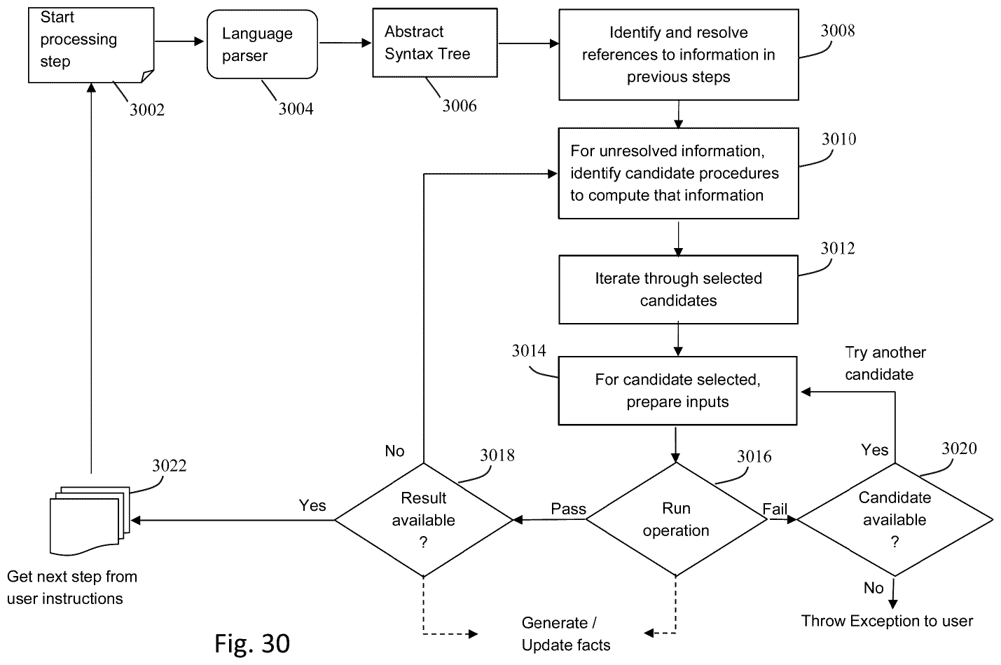

FIG. 30 provides an illustration of processing steps to generate a record of facts and procedure steps when executing an automation. Given an automation is a set of sequential steps, every step is a statement which instructs the automation engine on what to do next. This statement is written in a language, which in some embodiments comprises a natural language such as the English language.

At 3002, a first processing step is handled. A language parser 3004 is used to perform processing. The natural language statement is processed at runtime by first generating an Abstract Syntax Tree (AST) 3006 using the language parser 3004. This AST is generated based on the rules of a given programming language. Each node in the tree is representative of a construct which needs to be either: (a) Stored as-is; (b) Resolved further using information available from previous statements; and/or (c) Marked as unknown for lazy resolution (maybe in later statements).

Based on the AST, the system can identify the operational intent of the statement. For example, identification can be made that this can be a query, an action, a fact for later usage, etc. Every step generates a graph which links together the information newly provided (or referred to in an earlier statement) and the operation which needs to be performed.

Therefore, at 3008, the system will identify and resolve any references to information in the processing steps. To the extent there is any unresolved information, then at 3010, candidate procedures are identified to compute that information. The automation engine can use the graph to recommend procedures it supports (e.g., on a best efforts basis). For example, in some embodiments, this ranges from simple things like adding a number to more complex ones like extracting text from a document and creating a table. It runs these procedures and generates a result.

At 3012, the system will iterate through the selected candidates. At 3014, for a selected candidate, inputs are prepared for processing. At 3016, the operation is run using the selected candidate procedure. A determination is made whether the operation has passed or failed. If there is a failure, then at 3020, a check is made if another candidate is available. If so, then the system returns back to 3014 to continue processing with the next candidate. It is possible that none of the recommended procedures generate an answer but rather throw exceptions, in which case the automation engine throws the most precise exception to the user to answer.

If there is a pass at 3016, then a determination is made at 3018 whether a result is available. If not, then the system will return back to 3010 to continue processing. However, if a result is available, then the system proceeds to 3022 to obtain a next step from the user instructions.

It is noted that facts are generated and stored in a database as a result of the running of operations in the system. Therefore, the execution of step 3016 will result in the saving of facts and procedures into the database. Similarly, the generation of a result from 3018 will also cause an update to the recorded information in the database.

All of the above information is just associated with a single step for a single run. These are repeated for all steps for every automation run in the automation system so that there is a richly populated database of facts and procedures within the system.

Given that the system saves all the inputs, facts and outputs (e.g., answers) of every step before computing the next step, this allows the system to have granular information of what has happened at each step across many (e.g., thousands of) runs of a single automation process.

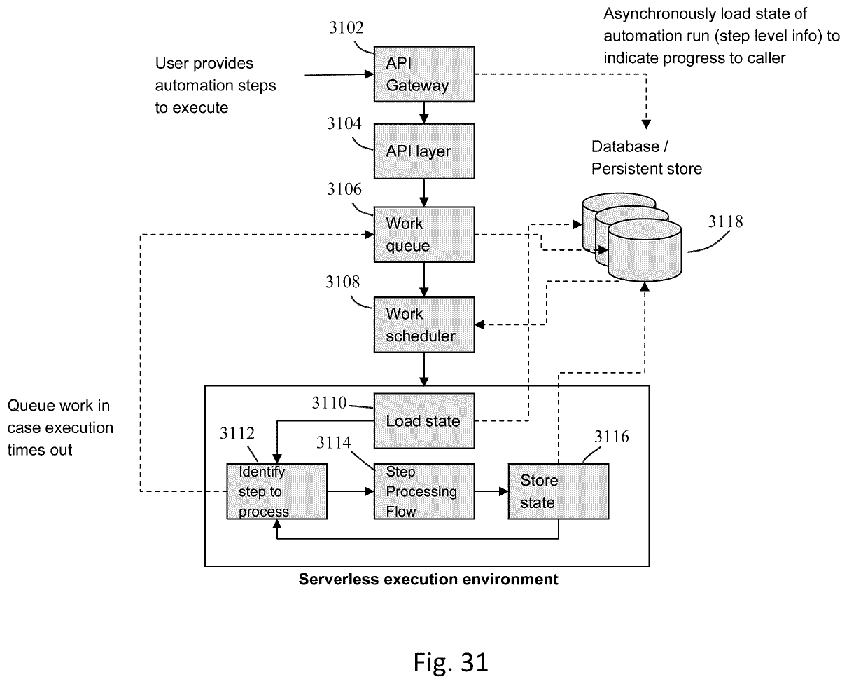

FIG. 31 shows an architecture of an automation system/platform with which embodiments of the invention may operate. To use the automation system/platform, the user will provide one or more requests to implement some form of automation, e.g., using a natural language format. The request may include automations as well as a context for the automations. According to embodiments of the invention, the requests from the user may also pertain to automation upgrades, import, and/or export requests.

The requests may be provide using any suitable interface vehicle. For example, the user may interact with the system using an interface that makes API calls, e.g., HTTP-based API calls. In this scenario, an API gateway 3102 acts as a service to receive the incoming requests into the automation system. An API layer 3104 may include an API handler having business logic to handle the incoming APIs.

One or more persistent stores 3118 may be used to hold persistent state for the automation runs. For example, a first persistent store can be used to hold human readable forms of stored materials. These would include the automations in human readable form, as well as context information and/or system metadata in human readable form. A second persistent store can be used to hold the lower level representations of the human readable content. For example, when automation processing is performed to generate lower level executable code and/or procedures based upon natural language requests from the user, the natural language form of the automation is stored in the first persistent store while the generated lower level representation for the automation (e.g., in binary code) is stored in the second persistent store. Similarly, higher level human readable versions of state and context are stored in the first persistent store while lower level representations of execution state would be stored in the second persistent store. In some embodiments, the system will asynchronously load the state of the automation runs (e.g., step level information) to indicate progress to a user/caller. These persistent stores may be implemented using any suitable storage medium. For example, these stores may be implemented as cloud-based storage offered by a cloud vendor. As another example, these stores may be implemented using storage devices (e.g., HDDs or SSDs) that are located in on-premises data centers.

When it is desired to run an automation, a system orchestrator may be used to execute the automation. The system orchestrator interfaces with a natural language execution engine that includes a work queue 3106 and a work handler/scheduler 3108. The automation requests are placed onto the work queue 3106 to be processed by the work handler to actually execute the automations. The persistent store will be accessed to obtain the low level executable representations of the automations to be executed.

With regards to stored data representations, it is noted that the user and system data representation are at a high-enough level that it is unlikely to change significantly over time, or become too complex to easily interpret without complicated version-aware logic. For this, the system uses natural language to represent automations. Users write automations using a natural language such as English, and the system stores the English they write as it is (potentially after some validation and normalization), along with some extra information like the name they give the automation (metadata). Furthermore, the system also stores dependencies the automations may have, by their name (automations may use services that have APIs, which are dependencies, or they may use common functionality that is available in a library or some sort; these are both dependencies). Lastly, automations may depend on external information, such as passwords, constants, and learned values or techniques (mini-automations) for dealing with any exceptions that may arise when a given automation runs. These are also gathered and normalized to a form that can be represented as English.

Thus, it is possible to store a given set of automations and any dependencies they need to run using a high-level English representation. This representation may be packaged in a format that is also machine readable, like JSON, to enable both human and machine to interpret it easily. A possible type of representation is a “book” or “document” that represents a simple automation and its associated dependencies. It is noted that this example representation corresponds to pure natural language, but it is evident that a machine representation can be mixed with this at various levels.

An execution environment (e.g., a serverless execution environment) may be used to process the automation workload. At 3110, certain states may be loaded for the operation being processed. For example, an operation may resume processing from an earlier execution, and as such, state would be loaded from the earlier execution. At 3112, a specific step is identified for processing. At 3114, the step processing flow is executed. Thereafter, at 3116, state is stored for the step execution.

Based upon the recorded items of information for the automation, an approach can be implemented to raise the accuracy of automation runs to detect anomalies in facts generated at every step. With a single automation process that can run many times (e.g., hundreds or thousands of times), the users would be naturally inclined to extract information from the runs.

For example, consider a desire to identify customers whose purchases include item X, Y, Z in last 6 months. This information may not be part of the final result of an automation run, e.g., the final result could be simply correlating an invoice with a payment (invoice X is met by payment id Y). However, this information of interest is computed as part of intermediate steps of a run. Therefore, one would know the customer name and items purchased (at a given step) while trying to figure out if a payment matches an invoice.

In current software automation processes, looking up results of intermediate steps requires users to modify automations, e.g., to save the results of step N to a database. However, modifying an automation post-run means that the user is unable to get any insights from previous runs.

With embodiments of the present invention, such insights can now be obtained by reviewing the recorded history of steps from prior automation runs.

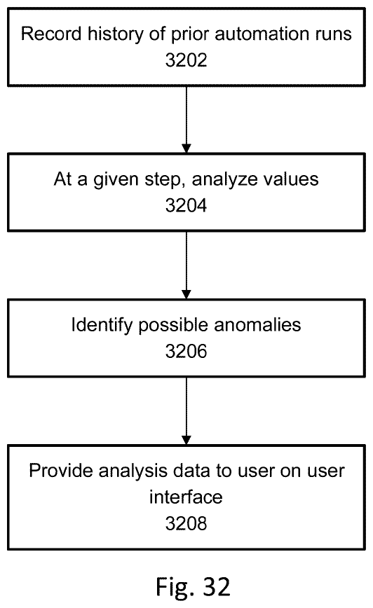

FIG. 32 shows a flowchart of an approach to implement some embodiments of the invention. At 3202, a history is recorded of automation runs. This action may be performed, for example, using any of the techniques described above. Specifically, the recorded information will include a description of each step that was performed, along with certain fact information recorded for that step. Such fact information may include, for example, information such as inputs, outputs, state information, and intermediate calculated values.

At a given step, at 3204, analysis can then be performed upon the values for that step. For example, for a new run at a given step, if a fact was created with a given value, then the system can compare the value across previously successful runs. Since there are recorded facts for prior runs, this means that there are likely to be multiple prior data points that can be used to analyze the current run.

At 3206, the fact data can then be checked for possible anomalies. Any suitable approach can be taken check for the presence of anomalies. For example, a statistical analysis can be performed identify any significant deviations, e.g., by calculating distance values from a mean to provide information about how the current individual value varies from the average. Thresholds can be established to set the deviation that will trigger a warning to the user regarding an anomaly. Machine learning can also be used to perform anomaly detection upon the data. In addition, as discussed in more detail below, a Large Language Models (LLM) can also be employed for anomaly detection. In any case, information about automation accuracy may be generated. As previously noted, automation accuracy can be defined as ratio of: (Runs with correct results)/(Total number of runs with results).

At 3208, analysis data can be presented to the user from the above analysis. This presentation may be as simple as writing the analysis data to a log file that can later be reviewed by the user. As discussed in more detail below, a dynamic dashboard may be implemented to provide the analysis data to the user.

This portion of the disclosure provides an approach to implement anomaly analysis and detection using a LLM (which may also be referred to herein as “generative AIs”). Specifically, the LLM can be used in conjunction with the natural language processing techniques described above to perform analysis upon the recorded step-based data.

With this embodiment of the invention, anomaly detection can be leveraged using LLMs, which are adept at discerning anomalies given a natural language command. For example, the command can simply be a list of previous values and the new value.

To explain, consider the example situation escribed above, where the previous values are 123456, 234567, 76234, 128654, 0912345″. The new value is “10234S”. If the new value is similar to previous values, a prompt can be used to the LLM to requests analysis for “Similar” and/or “Different” for the data, and to requests an explanation of the analysis.

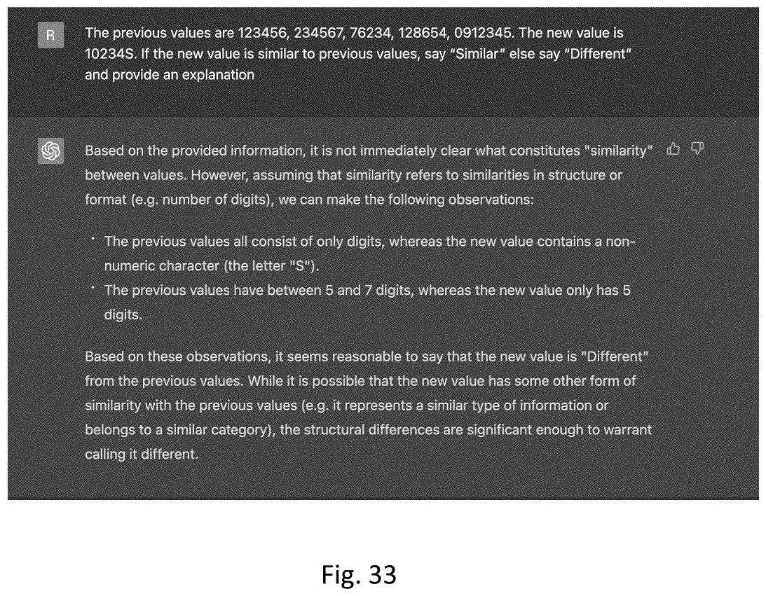

FIG. 33 shows an example of an example prompt that or provided to a LLM for this type of analysis. As can be seen, the LLM provides a response that identifies the possible anomaly, which in this example scenario is the fact that the letter “S” is part of the data in the current run, where such characters are not present in previous runs.

By leveraging user data and LLM, the system can raise an exception to the user to notify them of an anomaly detected in the run and wait for reviewed feedback from the user. This allows users to catch errors at their inception and remedy them, thereby saving effort, time and money.

An example of a suitable LLM that can be used is ChatGPT. This specific LLM currently uses open sourced GPT-3.5 LLM, which is fine-tuned with Reinforcement Learning from Human Feedback (RLHF). It is noted, however, that the invention is not limited to this specific LLM, and indeed can be used with any suitable type of LLM.

In addition, for a new run at a given step, if a significant quantity of facts is created, then the system can compare the number of those facts created across all previously successful runs and detect anomalies if any.

For example, consider an example scenario in which the number of facts created in the previous runs is: 37, 13, 37, 24, 23, 10, 15. However, the number of facts created in a current run is: 84. Anomaly detection can be performed upon this situation to determine whether an anomaly exists with regards to the number of facts that is created.

Any suitable type of anomaly detection may be used to perform the analysis, e.g., using statistical analysis, machine learning, or a LLM.

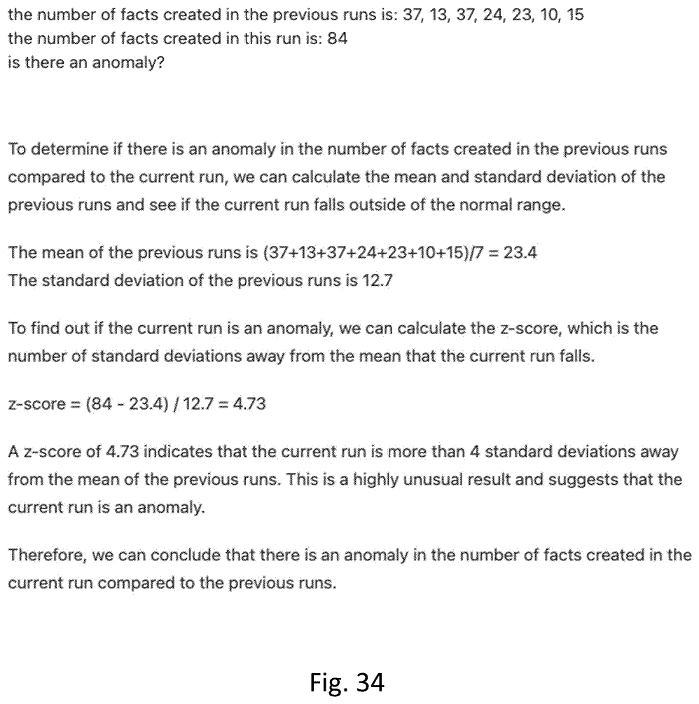

FIG. 34 shows an example approach of asking a LLM to check for an anomaly in this situation. Here, the LLM has determined that the situation does indeed present an anomaly, since there is a significant statistical deviation from the mean of previous results.

Therefore, by leveraging attributes of the user data (e.g., how many facts were created) and LLMs, the system can detect the anomaly and raise a question to the user. For example, the user can be presented with this information/question: “Abnormally high/low facts discovered in this run, is this expected?” This type of analysis result presented to the user therefore asks the user to help resolve the exception with a response. Example of valid response may include: “Yes”, “No”, “YesButIgnoreForFutureRuns”.

Therefore, the present embodiment of the invention provides a significant advantage, since in traditional automation, anomaly detection happens after the run is complete, at which point it might be too late. This is because it is difficult to roll back changes that have already been made. In the current embodiment, the user is alerted to the anomaly as part of the automation run, and their input is used to complete the automation, with no side effects that need to be fixed after the fact.

This portion of the disclosure provides an approach to implement a dynamic dashboard to present information and/or analysis results to a user.

With embodiments of the invention, queries can be posed to this collected set of data. This permits the user to obtain insights into the facts that are collected/used during an automation run. What is significant is that with prior approaches, only the resultant data is reviewable by a user. Here, since every fact is recorded for every step of the automation, the user can query into not just the final results, but also all of the intermediate fact data that is used or generated through the automation processing.

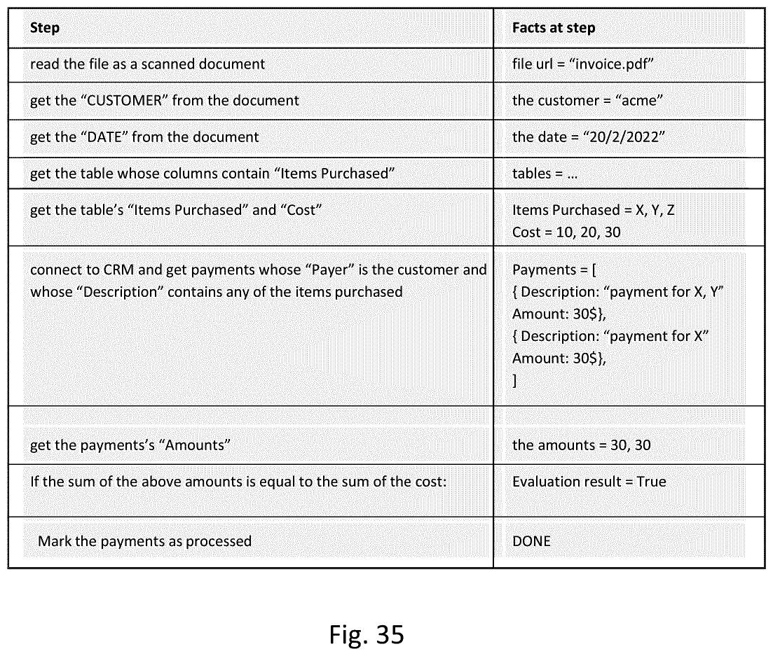

To help with this explanation, consider the contents of FIG. 35 which shows an illustration of information that may be recorded for an example automation run. Here, the sequence of steps that are executed are recorded in order. Each entry in the recorded information includes both the step itself as well as the facts for the step. Any suitable set of information may be stored for the automation. For example, the recorded information may include a unique identifier for the step, input information, output information, calculations that are performed, results, snapshots, and knowledge states. This information is all persisted in a data store.

Now consider if a user is interested in querying this data. For example, consider if a user would like to check for: “Customers whose purchases include item X in last 6 months”.

In a traditional automation, the only available information from a run would be “DONE” or not—based only on the end result. With the current embodiment, the user has a complete control to view how the automation is run and to query the information that is available at each step.

Since different runs have identical steps, users can query all runs for information of interest. This allows the user to view, analyze, and compare the information from those different runs.

To implement this, every step can have a unique identifier in some embodiments, e.g., referred to herein as a step ID. This cannot simply be an incrementing ID since users have the ability to modify automation logic over time, e.g., users can add a new step at start called ‘get the document's “Invoice #”’. The idea is that the step ID is semantically unique and identifiable. In the above example, irrespective of adding a new step, one should still be able to identify the steps of interest (customer, date etc. . . . ).

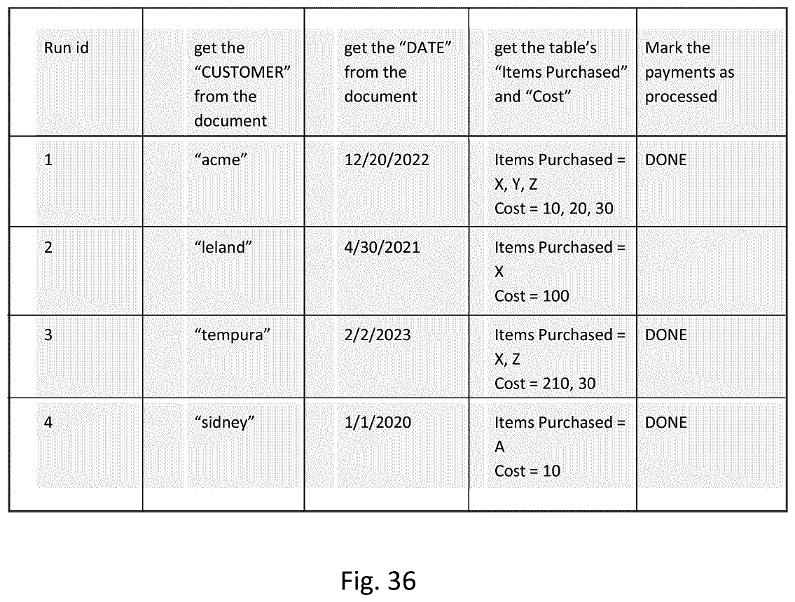

Once an identification can be made of a step based on its step ID, this allows the system to pull the facts of interest from the same step across multiple runs. For example, shown in FIG. 36 is a dynamic dashboard created by the user with selections from data such as recorded in FIG. 35. In the current situation, the user would be interested in some or all of the following steps: (a) get the “CUSTOMER” from the document; (b) get the “DATE” from the document; (c) get the table's “Items Purchased” and “Cost”; (d) Mark the payments as processed. This set of information is presented in the figure.

Once this type of dashboard is created, it can be searched and analyzed as desired by the user. At this point, the user may choose to review and/or filter the dashboard based on queries on its columns. For example, the user may choose to filter based upon: “Customers whose purchases include item X in last 6 months and whose payments are processed”

Therefore, what has been described is an improved approach to review and analysis a history of recorded facts for automation runs. This can be used to improve automation accuracy and to create dynamic dashboards.

### System Architecture Overview

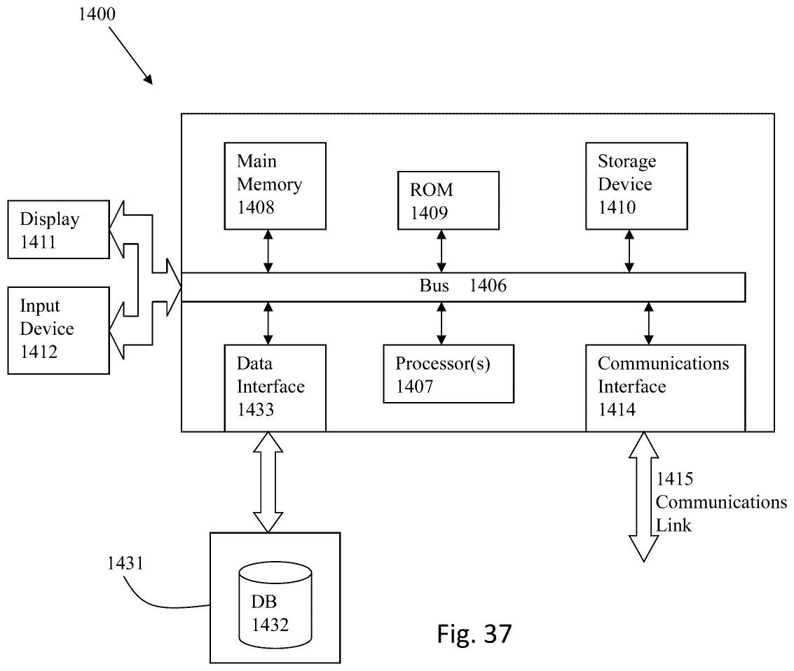

FIG. 37 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408. A database 1432 may be accessed in a computer readable medium 1431 using a data interface 1433.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

1. A method, comprising:
operating an automation that was implemented based upon natural language processing, wherein a history of executed steps is maintained along with corresponding facts for each step of the automation;
at a given step, analyzing a recorded fact against the facts that were recorded for the history executed steps for the automation; and
performing anomaly analysis on the recorded fact.

2. The method of claim 1, wherein an LLM is used to perform the anomaly analysis by generating a prompt that includes the recorded fact along with data from the facts that were recorded for the history executed steps for the automation.

3. The method of claim 1, wherein database is maintained to track the history of the executed steps and any corresponding facts.

4. The method of claim 1, wherein results from performing the anomaly analysis are presented to a user.

5. The method of claim 1, wherein a natural language representation of the automation corresponds to one or more ASTs.

6. The method of claim 1, wherein the history of the executed steps comprises a learned procedure.

7. A system, comprising:
a processor;
a memory for holding programmable code; and
wherein the programmable code includes instructions for operating an automation that was implemented based upon natural language processing,
wherein a history of executed steps is maintained along with corresponding facts for each step of the automation; at a given step, analyzing a recorded fact against the facts that were recorded for the history executed steps for the automation; and performing anomaly analysis on the recorded fact.

8. The system of claim 7, wherein an LLM is used to perform the anomaly analysis by generating a prompt that includes the recorded fact along with data from the facts that were recorded for the history executed steps for the automation.

9. The system of claim 7, wherein database is maintained to track the history of the executed steps and any corresponding facts.

10. The system of claim 7, wherein results from performing the anomaly analysis are presented to a user.

11. The system of claim 7, wherein a natural language representation of the automation corresponds to one or more ASTs.

12. The system of claim 7, wherein the history of the executed steps comprises a learned procedure.

13. A computer program product embodied on a computer readable medium, the computer readable medium having stored thereon a sequence of instructions which, when executed by a processor, performs:
operating an automation that was implemented based upon natural language processing, wherein a history of executed steps is maintained along with corresponding facts for each step of the automation;
at a given step, analyzing a recorded fact against the facts that were recorded for the history executed steps for the automation; and
performing anomaly analysis on the recorded fact.

14. The computer program product of claim 13, wherein an LLM is used to perform the anomaly analysis by generating a prompt that includes the recorded fact along with data from the facts that were recorded for the history executed steps for the automation.

15. The computer program product of claim 13, wherein database is maintained to track the history of the executed steps and any corresponding facts.

16. The computer program product of claim 13, wherein results from performing the anomaly analysis are presented to a user.

17. The computer program product of claim 13, wherein a natural language representation of the automation corresponds to one or more ASTs.

18. The computer program product of claim 13, wherein the history of the executed steps comprises a learned procedure.
